(19) United States
(12) Patent Application Publication
(10) Pub. No.: US 2024/0373439 A1
(43) Pub. Date: Nov. 7, 2024

(54) COMMUNICATION METHOD, COMMUNICATION APPARATUS, ELECTRONIC DEVICE AND COMPUTER-READABLE STORAGE MEDIUM

(71) Applicants: SAMSUNG ELECTRONICS CO., LTD., Suwon-si, Gyeonggi-do (KR); BEIJING SAMSUNG TELECOMMUNICATIONS TECHNOLOGY RESEARCH CO., LTD., Beijing (CN)

(72) Inventors: Jingxing FU, Beijing (CN); Feifei SUN, Beijing (CN); Yi WANG, Beijing (CN)

(21) Appl. No.: 18/290,743

(22) PCT Filed: Jul. 22, 2022
(86) PCT No.: PCT/KR2022/010831

§ 371 Date: Jan. 19, 2024

(30) Foreign Application Priority Data
Jul. 23, 2021 (CN) 202110839439.3
Aug. 4, 2021 (CN) 202110891897.1

(51) Int. Cl. H04W 72/232; H04L 5/00; H04W 52/32; H04W 72/0446

(52) U.S. Cl. CPC H04W 72/232; H04L 5/0055; H04W 52/325; H04W 72/0446

(57) ABSTRACT

Embodiments of the disclosure provide a communication method, a communication apparatus, an electronic device and a computer-readable storage medium, and belong to the technical field of wireless communication. The method may comprise steps of: receiving configuration information, the configuration information being used for configuring at least two serving cells for transmitting uplink control information (UCI): receiving downlink control information (DCI) used for scheduling physical downlink shared channels (PDSCHs); determining, according to the DCI, physical uplink control channel (PUCCH) resources for transmitting UCI of PDSCHs, wherein, when PUCCH resources indicated by at least two DCIs are PUCCH resources of at least two serving cells overlapped in time domain, PUCCH resources indicated by a specified DCI in the at least two DCIs are determined as PUCCH resources for transmitting UCI of PDSCHs scheduled by the at least two DCIs. In accordance with the method provided by the embodiments of the disclosure, the problem how to transmit UCI when PUCCH resources of different serving cells used for transmitting UCI are overlapped in time domain can be solved, and the actual application requirements can be better satisfied.

### TECHNICAL FIELD

The disclosure relates to the technical field of wireless communication, and in particular to a communication method, a communication apparatus, an electronic device and a computer-readable storage medium.

### BACKGROUND ART

Fifth generation (5G) mobile communication technologies define broad frequency bands such that high transmission rates and new services are possible, and can be implemented not only in “Sub 6 GHz” bands such as 3.5 GHZ, but also in “Above 6 GHZ” bands referred to as mmWave including 28 GHZ and 39 GHz. In addition, it has been considered to implement sixth generation (6G) mobile communication technologies (referred to as Beyond 5G systems) in terahertz bands (for example, 95 GHz to 3 THZ bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (cMBB), Ultra Reliable Low Latency Communications (URLLC), and massive Machine-Type Communications (mMTC), there has been ongoing standardization regarding beamforming and massive Multiple-Input Multiple-Output (MIMO) for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of Bandwidth Part (BWP), new channel coding methods such as a Low Density Parity Check (LDPC) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as Vehicle-to-everything (V2X) for aiding driving determination by autonomous vehicles based on information regarding positions and states of vehicles transmitted by the vehicles and for enhancing user convenience, New Radio Unlicensed (NR-U) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, Integrated Access and Backhaul (IAB) for providing a node for network service area expansion by supporting a wireless backhaul link and an access link in an integrated manner, mobility enhancement including conditional handover and Dual Active Protocol Stack (DAPS) handover, and two-step random access for simplifying random access procedures (2-step random-access channel (RACH) for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting Augmented Reality (AR), Virtual Reality (VR), Mixed Reality (MR) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using Orbital Angular Momentum (OAM), and Reconfigurable Intelligent Surface (RIS), but also full-duplex technology for increasing frequency efficiency of 6G mobile communication technologies and improving system networks, AI-based communication technology for implementing system optimization by utilizing satellites and Artificial Intelligence (AI) from the design stage and internalizing end-to-end AI support functions, and next-generation distributed computing technology for implementing services at levels of complexity exceeding the limit of UE operation capability by utilizing ultrahigh-performance communication and computing resources.

### DISCLOSURE OF INVENTION

### Technical Problem

The disclosure provides a method and device to transmit uplink control information in a wireless communication system.

### Solution to Problem

An objective of the disclosure is to solve at least one of the technical deficiencies in the existing communications modes, further improve the communication modes and better satisfy the actual communication requirements. In order to achieve this objective, the disclosure provides the following technical solutions.

In one aspect, the disclosure provides a communication method executed by a user equipment (UE) in a wireless communication system, wherein the method may comprise steps of: receiving configuration information, the configuration information being used for configuring at least two serving cells for transmitting uplink control information (UCI); receiving downlink control information (DCI) used for scheduling physical downlink shared channels (PDSCHs); determining, according to the DCI, physical uplink control channel (PUCCH) resources for transmitting UCI of PDSCHs, wherein, when PUCCH resources indicated by at least two DCIs are PUCCH resources of at least two serving cells overlapped in time domain, PUCCH resources indicated by a specified DCI in the at least two DCIs are determined as PUCCH resources for transmitting UCI of PDSCHs scheduled by the at least two DCIs.

In another aspect, the disclosure further provides a communication method executed by a base station in a wireless communication system, wherein the method may comprise steps of: transmitting configuration information to a UE, the configuration information being used for configuring at least two serving cells for transmitting UCI; and transmitting, to the UE, DCI used for scheduling PDSCHs, wherein, when PUCCH resources indicated by at least two DCIs are PUCCH resources of at least two serving cells overlapped in time domain, PUCCH resources indicated by a specified DCI in the at least two DCIs are determined as PUCCH resources for transmitting UCI of PDSCHs scheduled by the at least two DCIs.

In another aspect, an embodiment of the disclosure provides a communication apparatus, comprising: a transceiver module configured to receive configuration information used for configuring at least two serving cells for transmitting UCI, and configured to receive DCI used for scheduling PDSCHs; and a transmission resource determination module configured to determine, according to the DCI, PUCCH resources for transmitting UCI of PDSCHs, wherein, when PUCCH resources indicated by at least two DCIs are PUCCH resources of at least two serving cells overlapped in time domain, PUCCH resources indicated by a specified DCI in the at least two DCIs are determined as PUCCH resources for transmitting UCI of PDSCHs scheduled by the at least two DCIs.

In another aspect, an embodiment of the disclosure provides a communication apparatus, wherein the apparatus may be implemented as a base station, and the apparatus may comprise a transceiver module configured to: transmit configuration information to a UE, the configuration information being used for configuring at least two serving cells for transmitting UCI; and transmit, to the UE, DCI used for scheduling PDSCHs, wherein, when PUCCH resources indicated by at least two DCIs are PUCCH resources of at least two serving cells overlapped in time domain, PUCCH resources indicated by a specified DCI in the at least two DCIs are determined as PUCCH resources for transmitting UCI of PDSCHs scheduled by the at least two DCIs.

In another aspect, an embodiment of the disclosure provides an electronic device, comprising a processor and a memory, wherein the processor and the memory are connected to each other, the memory stores computer programs, and the processor executes the method according to any one of optional embodiments of the disclosure when running the computer programs.

Optionally, the electronic device can be a user equipment, and the processor can execute the communication method executed by a UE according to any one of optional embodiments of the disclosure when running the computer programs.

Optionally, the electronic device is a base station, and the processor executes the communication method executed by a base station according to any one of optional embodiments of the disclosure when running the computer programs.

In another aspect, an embodiment of the disclosure provides a computer-readable storage medium having computer programs stored thereon that, when run by a processor, execute the method according to any one of optional embodiments of the disclosure.

The beneficial effects achieved by the provided technical solutions will be described hereinafter in conjunction with specific optional embodiments.

### Advantageous Effects of Invention

According to an embodiment of the disclosure, resources for uplink transmission can be determined based on DCI.

According to an embodiment of the disclosure, uplink transmission power can be efficiently managed.

### BRIEF DESCRIPTION OF DRAWINGS

In order to explain the technical solutions in the embodiments of the disclosure more clearly, the accompanying drawings to be used in the description of the embodiments of the disclosure will be briefly illustrated below.

FIG. 1 is a schematic diagram of a wireless network according to an embodiment of the disclosure;

FIG. 2a is a schematic diagram of a wireless transmitting path according to an embodiment of the disclosure;

FIG. 2b is a schematic diagram of a wireless receiving path according to an embodiment of the disclosure;

FIG. 3a is a schematic structure diagram of a user equipment according to an embodiment of the disclosure;

FIG. 3b is a schematic structure diagram of a base station according to an embodiment of the disclosure;

FIG. 4 is a schematic diagram of a situation where UCI of a UE can be transmitted on different serving cells configured for the UE, according to an embodiment of the disclosure;

FIG. 5 is a flowchart of a communication method according to an embodiment of the disclosure;

FIG. 6 is a schematic diagram of determining PUCCH resources according to an example of the disclosure;

FIG. 7 is a schematic diagram of determining PUCCH resources according to another example of the disclosure;

FIG. 8 is an example of a schematic diagram of a method for using a transmission power control (TPC) command in DCI used for scheduling PDSCHs according to an embodiment of the disclosure;

FIG. 9 is another example of a schematic diagram of a method for using a TPC command in DCI used for scheduling PDSCHs according to an embodiment of the disclosure;

FIG. 10 is another example of a schematic diagram of a method for using a TPC command in DCI used for scheduling PDSCHs according to an embodiment of the disclosure;

FIG. 11 is another example of a schematic diagram of a method for using a TPC command in DCI used for scheduling PDSCHs according to an embodiment of the disclosure;

FIG. 12 is another example of a schematic diagram of a method for using a TPC command in DCI used for scheduling PDSCHs according to an embodiment of the disclosure;

FIG. 13 is another example of a schematic diagram of a method for using a TPC command in DCI used for scheduling PDSCHs according to an embodiment of the disclosure;

FIG. 14 is another example of a schematic diagram of a method for using a TPC command in DCI used for scheduling PDSCHs according to an embodiment of the disclosure;

FIG. 15 is another example of a schematic diagram of a method for using a TPC command in DCI used for scheduling PDSCHs according to an embodiment of the disclosure;

FIG. 16 is a schematic diagram of a situation where UCI in a serving cell group of a UE can be transmitted in uplink slots of a plurality of serving cells in the serving cell group, according to an embodiment of the disclosure;

FIG. 17 is a schematic diagram of determining PUCCH resources according to an example of the disclosure;

FIG. 18 is a schematic diagram of determining PUCCH resources according to another example of the disclosure; and

FIG. 19 is a schematic structure diagram of an electronic device according to an embodiment of the disclosure.

### MODE FOR THE INVENTION

The embodiments of the disclosure will be described in detail below, and the examples of the embodiments are illustrated in the accompanying drawings, throughout which the same or similar reference numerals refer to the same or similar elements or elements having the same or similar functions. The embodiments to be described below with reference to the accompanying drawings are exemplary, and are only used for explaining the disclosure, rather than being construed as limiting the disclosure.

It should be understood by those skilled in the art that, as used herein, the singular form “a”, “an” or “the” may be intended to include plural forms as well, unless otherwise stated. It should be further understood that the terms “comprise/comprising” used in the specification of the disclosure specify the presence of the stated features, integers, steps, operations, elements and/or components, but not exclusive of the presence or addition of one or more other features, integers, steps, operations, elements, components and/or combinations thereof. It should be understood that, when an element is “connected” or “coupled” to another element, this element may be directly connected or coupled to the other element, or there may be intervening elements therebetween. In addition, as used herein, the “connection” or “coupling” may comprise wireless connection or wireless coupling. As used herein, the term “and/or” comprises all or any of one or more associated listed items or combinations thereof.

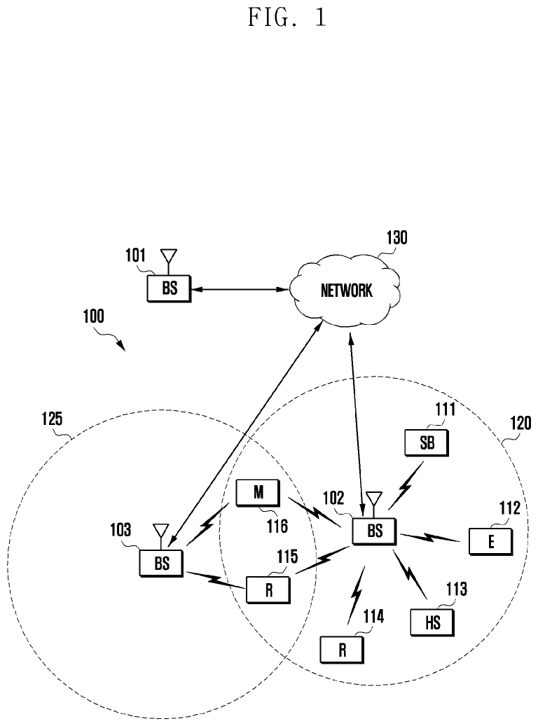

FIG. 1 shows an exemplary wireless network 100 according to various embodiments of the present disclose. The embodiment of the wireless network 100 shown in FIG. 1 is merely for the purpose of illustration. Other embodiments of the wireless network 100 can be used without departing from the scope of the present disclosure.

The wireless network 100 includes a gNodeB (gNB) 101, a gNB 102 and a gNB 103. The gNB 101 communicates with the gNB 102 and the gNB 103. The gNB 101 also communicates with at least one Internet protocol (IP) network 130 (e.g., Internet, private IP networks or other data networks).

Depending upon the network type, other well-known terms such as “base station” or “access point” can be used to replace “gNodeB” or “gNB”. For convenience, the terms “gNodeB” and “gNB” are used in this patent document to refer to a network infrastructure component that provides radio access for a remote terminal. In addition, depending upon the network type, other well-known terms such as “mobile station”, “user station”, “remote terminal”, “wireless terminal” or “user device” can be used to replace the “user equipment” or “UE”. For convenience, the terms “user equipment” and “UE” are used in this patent document to refer to a remote wireless device that wirelessly accesses to the gNB, no matter whether the UE is a mobile device (e.g., a mobile phone or a smart phone) or a generally-recognized immobile device (e.g., a desktop computer or a vending machine).

The gNB 102 provides wireless broadband access to a network 130 for a plurality of first UEs within a coverage region 120 of the gNB 102. The plurality of first UEs include: a UE 111, which can be located in a small enterprise (SB); a UE 112, which can be located in an enterprise (E); a UE 113, which can be located in a WiFi hotspot (HS); a UE 114, which can be located in a first residence (R); a UE 115, which can be located in a second residence (R); and, a UE 116, which can be a mobile device (M), for example, a cellular phone, a wireless laptop computer, a wireless PDA, etc. The gNB 103 provides wireless broadband access to the network 130 for a plurality of second UEs within a coverage region 125 of the gNB 103. The plurality of second UEs include a UE 115 and a UE 116. In some embodiments, one or more of gNBs 101 to 103 can communicate with each other and communicate with UEs 111 to 116 by using 5G, long term evolution (LTE), LTE-A, WiMAX or other advanced wireless communication technologies.

The dashed line shows the approximate range of the coverage regions 120 and 125, and this range is shown as being approximately circular only for the purpose of illustration and explanation. It should be clearly understood that the coverage region associated with the gNB (e.g., the coverage regions 120 and 125) can have other shapes, including irregular shapes, depending upon the configuration of the gNB and the change of the radio environment associated with natural obstacles and artificial obstacles.

As described in more detail below, one or more of the gNB 101, the gNB 102 and the gNB 103 comprises a 2D antenna array described in the embodiments of the present disclosure. In some embodiments, one or more of the gNB 101, the gNB 102 and the gNB 103 supports the codebook design and structure for a system having a 2D antenna array.

Although FIG. 1 shows an example of the wireless network 100, various alterations can be made to FIG. 1. For example, the wireless network 100 can comprise any number of gNBs and any number of UEs in any suitable arrangement. Furthermore, the gNB 101 can directly communicate with any number of UEs, and provide wireless broadband access to the network 130 for these UEs. Similarly, each of the gNBs 102 to 103 can directly communicate with the network 130 and provide direct wireless broadband access to the network 103 for UEs. In addition, the gNB 101, 102 and/or 103 can provide access to other or additional external networks (e.g., external telephone networks or other types of data networks).

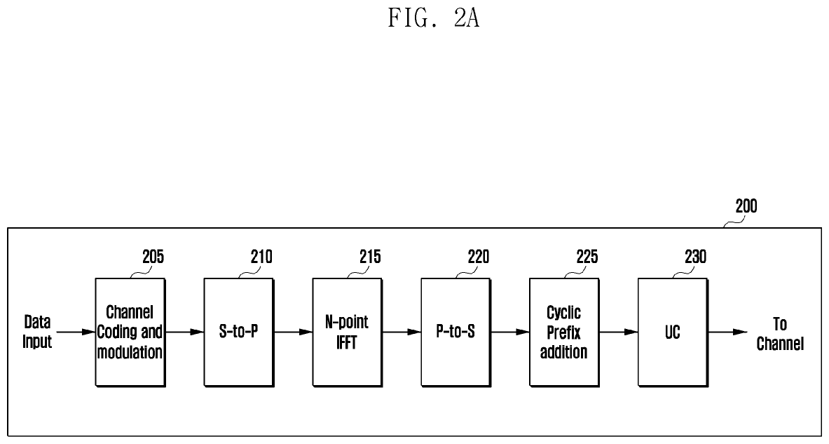

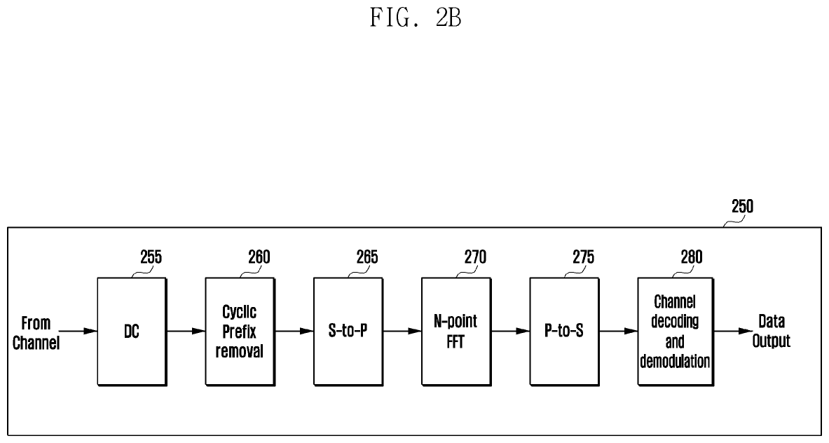

FIG. 2a shows an exemplary wireless transmitting path according to the disclosure. FIG. 2b shows an exemplary wireless receiving path according to the disclosure. In the following description, the transmitting path 200 can be described as being implemented in a gNB (e.g., gNB 102), while the receiving path 250 can be described as being implemented in a UE (e.g., UE 116). However, it should be understood that the receiving path 250 can be implemented in a gNB while the transmitting path 200 can be implemented in a UE. In some embodiments, the receiving path 250 is configured to support the codebook design and structure for a system having the 2D antenna array described in the embodiments of the present disclosure.

The transmitting path 200 comprises a channel coding and modulation block 205, a serial-to-parallel (S-to-P) block 210, an N-point inverse fast Fourier transform (IFFT) block 215, a parallel-to-serial (P-to-S) block 220, a cyclic prefix addition block 225 and an up-converter (UC) 230. The receiving path 250 comprises a down-converter (DC) 255, a cyclic prefix removal block 260, a serial-to-parallel (S-to-P) block 265, an N-point fast Fourier transform (FFT) block 270, a parallel-to-serial (P-to-S) block 275 and a channel decoding and demodulation block 280.

In the transmitting path 200, the channel coding and modulation block 205 receives a set of information bits, and performs coding (e.g., low-density parity check (LDPC) coding) and modulation on input bits (e.g., by quadrature phase shift keying (QPSK) or quadrature amplitude modulation (QAM)) to generate a sequence of frequency domain modulation symbols. The serial-to-parallel (S-to-P) block 210 converts (e.g., demultiplexes) a serial modulation symbol into parallel data to generate N parallel symbol streams, where N is the number of IFFT/FFT points used in the gNB 102 and the UE 116. The N-point IFFT block 215 performs an IFFT operation on the N parallel symbol streams to generate a time domain output signal. The parallel-to-serial block 220 converts (e.g., multiplexes) the parallel time domain output signal from the N-point IFFT block 215 to generate a serial time domain signal. The cyclic prefix addition block 225 interpolates a cyclic prefix into the time domain signal. The up-converter 230 modulates (e.g., up-converts) the output from the cyclic prefix addition block 225 to an RF frequency for transmission through a wireless channel. Before being converted to the RF frequency, the signal can also be filtered at the baseband.

The RF signal transmitted from the gNB 102 reaches the UE 116 after passing through the wireless channel, and an operation opposite to the operation at the gNB 102 is executed at the UE 116. The down-converter 255 down-converts the received signal to a baseband frequency, and the cyclic prefix removal block 260 removes the cyclic prefix to generate a serial time domain baseband signal. The serial-to-parallel block 265 converts the time domain baseband signal into a parallel time domain signal. The N-point FFT block 270 executes an FFT algorithm to generate N parallel frequency domain signals. The parallel-to-serial block 275 converts the parallel frequency domain signals into a sequence of modulation data symbols. The channel decoding and demodulation block 280 performs demodulation and decoding on the modulation symbols to restore the original input data stream.

Each of the gNBs 101 to 103 can implement a transmitting path 200 similar to transmitting to UEs 111 to 116 in a downlink, and can implement a receiving path 250 similar to receiving from UEs 111 to 116 in an uplink. Similarly, each of the UEs 111 to 116 can implement a transmitting path 200 for transmitting to gNBs 101 to 103 in an uplink, and can implement a receiving path 250 for receiving from gNBs 101 to 103 in a downlink.

Each of the components in FIGS. 2a and 2b can be implemented by only software, or implemented by a combination of hardware and software/firmware. As a specific example, at least some of the components in FIGS. 2a and 2b can be implemented by software, while other components can be implemented by configurable hardware or a mixture of software and configurable hardware. For example, the FFT block 270 and the IFFT block 215 can be implemented as configurable software algorithms, wherein the value of the point number N can be altered according to implementations.

In addition, although the use of FFT and IFFT has been described, it is merely illustrative and it should not be interpreted as limiting the scope of the present disclosure. Other types of transform can also be used, for example, discrete Fourier transform (DFT) and inverse discrete Fourier transform (IDFT) functions. It should be understood that, for DFT and IDFT functions, the value of the variable N may be any integer (e.g., 1, 2, 3, 4, etc.); while for FFT and IFFT functions, the value of the variable N may be any integer as the power of 2 (e.g., 1, 2, 4, 8, 16, etc.).

Although FIGS. 2a and 2b show the examples of the wireless transmitting and receiving paths, various alterations can be made to FIGS. 2a and 2b. For example, various components in FIGS. 2a and 2b can be combined, subdivided or omitted, and additional components can be added according to specific requirements. Moreover, FIGS. 2a and 2b are intended to show the examples of the types of transmitting and receiving paths that can be used in the wireless network. Any other suitable architecture can be used to support the wireless communication in the wireless network.

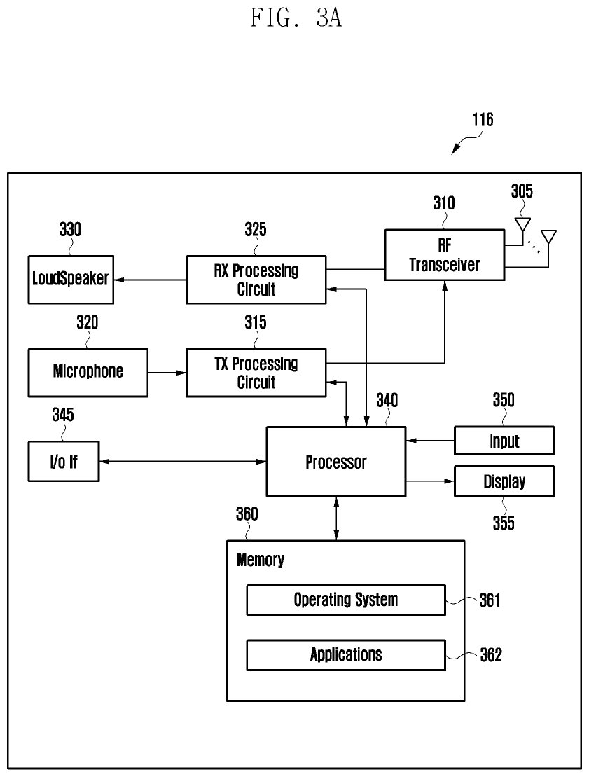

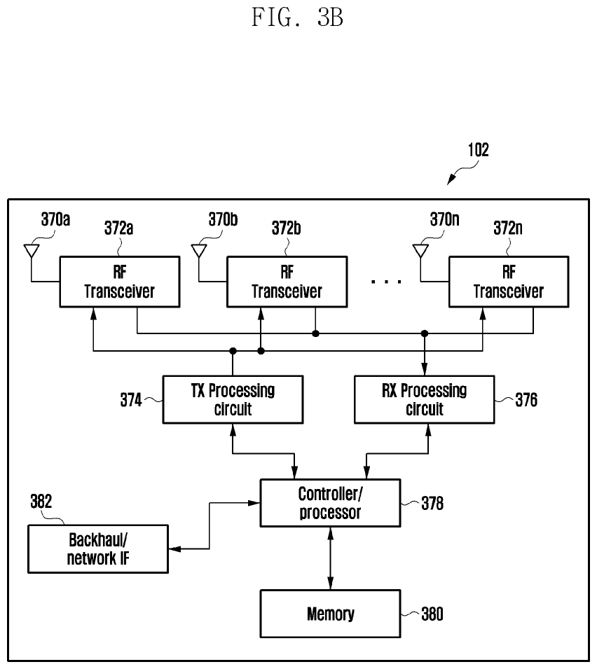

FIG. 3a shows an exemplary UE 116 according to the present disclosure. The embodiment of the UE 116 shown in FIG. 3a is merely for the purpose of illustration, and the UEs 111 to 115 in FIG. 1 can have the same or similar configuration. However, the UE has various configurations, and FIG. 3a does not limit the scope of the present disclosure to any specific implementation of the UE.

The UE 116 comprises an antenna 305, a radio frequency (RF) transceiver 310, a transmitting (TX) processing circuit 315, a microphone 320 and a receiving (RX) processing circuit 325. The UE 116 further comprises a loudspeaker 330, a processor/controller 340, an input/output (I/O) interface 345, an input device(s) 350, a display 355 and a memory 360. The memory 360 comprises an operating system (OS) 361 and one or more applications 362.

The RF transceiver 310 receives, from the antenna 305, an incoming RF signal transmitted by the gNB in the wireless network 100. The RF transceiver 310 down-converts the incoming RF signal to generate an intermediate-frequency (IF) or baseband signal. The IF or baseband signal is transmitted to the RX processing circuit 325, and the RX processing circuit 325 performs filtering, decoding and/or digitization on the baseband or IF signal to generate the processed baseband signal. The RX processing circuit 325 transmits the processed baseband signal to the loudspeaker 330 (e.g., for voice data) or transmitted to the processor/controller 340 (e.g., for network browsing data) for further processing.

The TX processing circuit 315 receives the analog or digital voice data from the microphone 320 or receives other outgoing baseband data (e.g., network data, e-mail or interactive video game data) from the processor/controller 340. The TX processing circuit 315 performs encoding, multiplexing and/or digitization on the outgoing baseband data to generate the processed baseband or IF signal. The RF transceiver 310 receives the processed outgoing baseband or IF signal from the TX processing circuit 315, and up-converts the baseband or IF signal into the RF signal transmitted by the antenna 305.

The processor/controller 340 can comprise one or more processors or other processing devices, and execute the OS 361 stored in the memory 360 so as to control the overall operation of the UE 116. For example, the processor/controller 340 can control the reception of forward channel signals and the transmission of backward channel signals through the RF transceiver 310, the RX processing circuit 325 and the TX processing circuit 315 according to the well-known principles. In some embodiments, the processor/controller 340 comprises at least one microprocessor or microcontroller.

The processor/controller 340 can also execute other processes and programs residing in the memory 360, for example, channel quality measurement and reporting operations for a system having the 2D antenna array described in the embodiments of the present disclosure. The processor/controller 340 can migrate data into or out of the memory 360 according to the requirements of the execution process. In some embodiments, the processor/controller 340 is configured to execute the application 362 on the basis of the OS 361 or in response to the signal received from the gNB or the operator. The processor/controller 340 is also coupled to the I/O interface 345, and the I/O interface 345 provides the UE 116 with the ability to be connected to other devices such as laptop computers and handheld computers. The I/O interface 345 is a communication path between these accessories and the processor/controller 340.

The processor/controller 340 is also coupled to the input device(s) 350 and the display 355. The operator of the UE 116 can use the input device(s) 350 to input data into the UE 116. The display 355 can be a liquid crystal display or other displays capable of presenting text and/or at least finite graphics (e.g., from a website). The memory 360 is coupled to the processor/controller 340. A part of the memory 360 can comprise a random access memory (RAM), while the other part of the memory 360 can comprise a flash memory or other read only memories (ROMs).

Although FIG. 3a shows an example of the UE 116, various alterations can be made to FIG. 3a. For example, various components in FIG. 3a can be combined, subdivided or omitted, and additional components can be added according to specific requirements. As a specific example, the processor/controller 340 can be divided into a plurality of processors, for example, one or more central processing units (CPUs) and one or more graphic processing units (GPUs). Moreover, although FIG. 3a shows the UE 116 configured as a mobile phone or a smart phone, the UE can be configured to be operated as other types of mobile or immobile devices.

FIG. 3b shows an exemplary gNB 102 according to the present disclosure. The embodiment of the gNB 102 shown in FIG. 3b is merely for the purpose of illustration, and other gNBs in FIG. 1 can have the same or similar configuration. However, the gNB has various configurations, and FIG. 3b does not limit the scope of the present disclosure to any specific implementation of the gNB. It is to be noted that the gNB 101 and the gNB 103 can comprise a structure the same as or similar to that of the gNB 102.

As shown in FIG. 3b, the gNB 102 comprises a plurality of antennas 370a to 370n, a plurality of RF transceivers 372a to 372n, a TX processing circuit 374 and an RX processing circuit 376. In some embodiments, one or more of the plurality of antennas 370a to 370n comprise a 2D antenna array. The gNB 102 further comprises a controller/processor 378, a memory 380 and a backhaul or network interface 382.

The RF transceivers 372a to 372n receive incoming RF signals from the antennas 370a to 370n, for example, signals transmitted by the UE or other gNBs. The RF transceivers 372a to 372n down-convert the incoming RF signals to generate IF or baseband signals. The IF or baseband signals are transmitted to the RX processing circuit 376, and the RX processing circuit 376 performs filtering, decoding and/or digitization on the baseband or IF signals to generate the processed baseband signals. The RX processing circuit 376 transmits the processed baseband signals to the controller/processor 378 for further processing.

The TX processing circuit 374 receives analog or digital data (e.g., voice data, network data, e-mail or interactive video game data) from the controller/processor 378. The TX processing circuit 374 performs encoding, multiplexing and/or digitization on the outgoing baseband data to generate the processed baseband or IF signal. The RF transceivers 372a to 372n receive the processed outgoing baseband or IF signal from the TX processing circuit 374, and up-convert the baseband or IF signal into the RF signals transmitted by the antennas 370a to 370n.

The controller/processor 378 can comprise one or more processors or other processing devices for controlling the overall operation of the gNB 102. For example, the controller/processor 378 can control the reception of forward channel signals and the transmission of backward channel signals through the RF transceivers 372a to 372n, the RX processing circuit 376 and the TX processing circuit 374 according to the well-known principles. The controller/processor 378 can also support additional functions, such as more advanced wireless communication functions. For example, the controller/processor 378 can execute a BIS process, for example, by a blind interference sensing (BIS) algorithm, and decode the received signal from which the interference signal is removed. The controller/processor 378 can support, in the gNB 102, any one of various other functions. In some embodiments, the controller/processor 378 comprises at least one microprocessor or microcontroller.

The controller/processor 378 can also execute programs and other processes (e.g., the basic OS) residing in the memory 308. The controller/processor 378 can also support channel quality measurement and reporting for a system having the 2D antenna array described in the embodiments of the present disclosure. In some embodiments, the controller/processor 378 supports the communication between entities such as web RTCs. The controller/processor 378 can migrate data into or out of the memory 380 according to the requirements of the execution process.

The controller/processor 378 is also coupled to the backhaul or network interface 382. The backhaul or network interface 382 allows the gNB 102 to communicate with other devices or systems through a backhaul connection or a network. The backhaul or network interface 382 can support communication through any suitable wired or wireless connection(s). For example, when the gNB 102 is implemented as a part of a cellular communication system (e.g., a cellular communication system supporting 5G or new radio access technology or NR, LTE or LTE-A), the backhaul or network interface 382 can allow the gNB 102 to communicate with other gNBs through a wired or wireless backhaul connection. When the gNB 102 is implemented as an access point, the backhaul or network interface 382 can allow the gNB 102 to communicate with a larger network (e.g., Internet) through a wired or wireless local area network or through a wired or wireless connection. The backhaul or network interface 382 comprises any suitable structure that supports communication through a wired or wireless connection, e.g., the Ethernet or an RF transceiver.

The memory 380 is coupled to the controller/processor 378. A part of the memory 380 can comprise an RAM, while the other part of the memory 380 can comprise a flash memory or other ROMs. In some embodiments, a plurality of instructions such as the BIS algorithm are stored in the memory. The plurality of instructions are configured to cause the controller/processor 378 to execute the BIS process and decode the received signal after at least one interference signal determined by the BIS algorithm is removed.

As described in more detailed below, the transmitting and receiving paths of the gNB 102 (implemented by using the RF transceivers 372a to 372n, the TX processing circuit 374 and/or the RX processing circuit 376) support aggregated communication with FDD cells and TDD cells.

Although FIG. 3b shows an example of the gNB 102, various alterations can be made to FIG. 3b. For example, the gNB 102 can comprise any number of each component shown in FIG. 3a. As a specific example, the access point can comprise many backhaul or network interfaces 382, and the controller/processor 378 can support a routing function to route data between different network addresses. As another specific example, although it is shown that the gNB comprises a single instance of the TX processing circuit 374 and a single instance of the RX processing circuit 376, the gNB 102 can comprise a plurality of instances of each of the TX processing circuit and the RX processing circuit (for example, each RF transceiver corresponds to one instance).

It should be understood that the solutions provided in the embodiments of the disclosure can be applied to, but not limited, the above wireless network.

The technical solutions of the disclosure and how to solve the above technical problems by the technical solutions of the disclosure will be described below in detail by specific embodiments. The following specific embodiments can be combined with each other, and the same or similar concepts or processes may not be repeated in some embodiments. The embodiments of the disclosure will be described below with reference to the accompanying drawings. The text and the accompanying drawings in the following description are merely provided as examples to help readers to understand the present disclosure. They are not intended to limit the scope of the present disclosure in any way. Although some embodiments and examples have been provided, based on the contents disclosed herein, it is obvious to those skilled in the art that the illustrated embodiments and examples can be altered without departing from the scope of the present disclosure.

In a wireless communication system, the reception of PDSCHs and physical uplink shared channels (PUSCHs) is scheduled through downlink control information (DCI) transmitted by physical downlink control channels (PDCCHs). A UE can receive DCI transmitted by a base station, and can also transmit uplink control information (UCI) to the base station, so as to notify the information related to the current UE state to the base station. Hybrid automatic repeat-request acknowledgement (HARQ-ACK) information, channel state information (CSI) and scheduling request (SR) are called UCI.

An embodiment of the disclosure provides a communication method. The communication method can be applied to the transmission of UCI, and the transmission method for UCI will be described below. In the embodiment of the disclosure, the UCI may comprise at least one of HARQ-ACK information (also directly referred to as HARQ-ACK), CSI information and SR. The following description of some embodiments is given by taking HARQ-ACK as an example. However, it should be understood that it is also applicable to the transmission of other UCI.

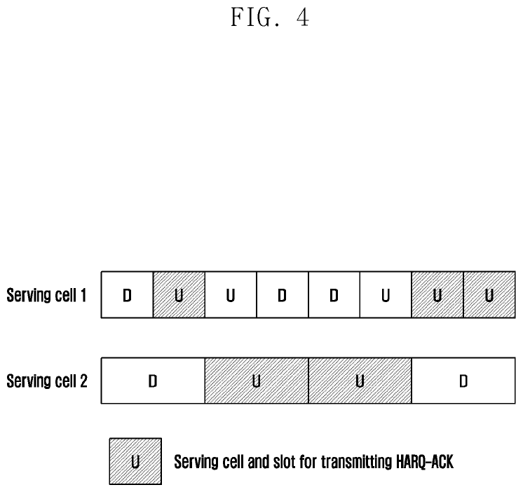

When a UE is configured with more than one uplink serving cell by a base station, in order to reduce the transmission delay of HARQ-ACK and balance the load on each serving cell, the UE can transmit UCI on at least two serving cells. FIG. 4 is a schematic diagram of a situation where UCI of a UE can be transmitted on different serving cells configured for the UE, according to an embodiment of the disclosure. In the example shown in FIG. 4, the serving cell 1 and the serving cell 2 are both serving cells of the UE. The rectangular box of “U” in FIG. 4 indicates a slot for transmitting the UCI (e.g., HARQ-ACK), i.e., an uplink slot for the serving cells. The rectangular box of “D” in FIG. 4 indicates a slot for transmitting the DCI, i.e., a downlink slot for the serving cells. In different slots, the HARQ-ACK of the UE can be transmitted on different serving cells. In this case, how to determine physical uplink control channel (PUCCH) resources used for transmitting UCI and how to control the transmission power of PUCCHs are problems to be solved.

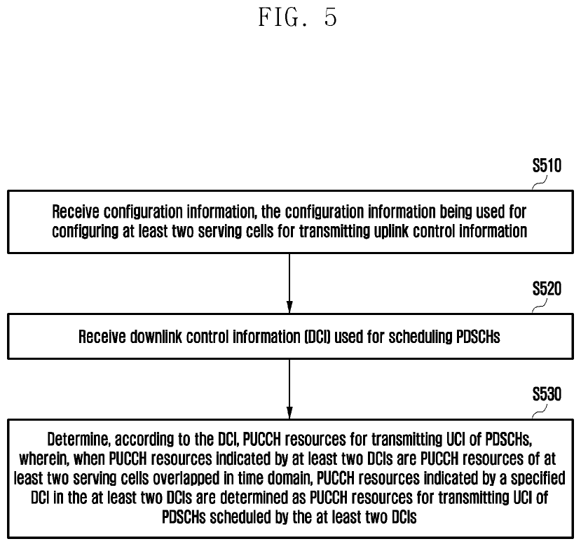

In view of the above problems, in order to more flexibly configure PUCCH resources used for transmitting UCI so as to better balance the load on each serving cell and reduce the transmission delay of UCI (e.g., HARQ-ACK), an embodiment of the disclosure provides a communication method. The method can be executed by a UE. FIG. 5 is a flowchart of a communication method according to an embodiment of the disclosure. As shown in FIG. 5, the method may comprise the following steps.

Step S510: Configuration information is received, the configuration information being used for configuring at least two serving cells for transmitting UCI.

A base station can configure, through the configuration information and for a UE, one or more serving cells for transmitting UCI. That is, the UE can determine, according to the configuration, serving cells capable of transmitting UCI. Optionally, the serving cells that can be used by the UE to transmit UCI may be at least two serving cells. Optionally, if it is negotiated through a protocol that the primary cell of the UE is a serving cell capable of transmitting UCI, the configuration information can be used for configuring at least one serving cell for transmitting UCI, and the at least one serving cell and the primary cell of the UE are at least two serving cells that can be used by the UE to transmit UCI.

Step S520: DCI used for scheduling PDSCHs is received.

Step S530: PUCCH resources for transmitting UCI of PDSCHs are determined according to the DCI, wherein, when PUCCH resources indicated by at least two DCIs are PUCCH resources of at least two serving cells overlapped in time domain, PUCCH resources indicated by a specified DCI in the at least two DCIs are determined as PUCCH resources for transmitting UCI of PDSCHs scheduled by the at least two DCIs.

Based on the method provided in the embodiment of the disclosure, in the DCI used for scheduling PDSCHs received by the UE, if PUCCH resources used for transmitting multiple (including two) UCIs are on at least two serving cells of the UE and the PUCCH resources are overlapped in time domain, the UE can transmit the multiple UCIs by using PUCCH resources indicated in a specified DCI received from the base station, thereby realizing the flexible configuration of PUCCH resources. The specified DCI being specifically which DCI in the at least two DCIs can be configured according to actual needs.

In one optional embodiment of the disclosure, the specified DCI in the at least two DCIs is any one of the following:
the last received DCI in the at least two DCIs;
the last received DCI containing first indication information in the at least two DCIs;
the first received DCI in the at least two DCIs; or
the first received DCI containing first indication information in the at least two DCIs;
wherein the first indication information is used for indicating serving cells where PUCCH resources are located.

Optionally, the specified DCI may be the last received DCI in the at least two DCIs. In this way, the base station can indicate, in the last time, PUCCH resources used for transmitting the multiple UCIs, so that the PUCCH resources can be better selected.

Optionally, the specified DCI may be the last received DCI containing first indication information in the at least two DCIs. In this way, the serving cells where the PUCCH resources used for transmitting the multiple UCIs are located can be flexibly indicated by the base station through the first indication information in the DCI.

The method for determining PUCCH resources according the disclosure will be described below by several optional embodiments, and the UCI in these embodiments takes HARQ-ACK as an example.

### First Section: Method for Determining PUCCH Resources

The DCI formats (e.g., DCI format 1-1, DCI format 1-2) in some PDCCHs for scheduling PDSCHs contain an indication field (i.e., the first indication information) of a serving cell, and the indication field of the serving cell indicates a serving cell of PUCCH resources for transmitting HARQ-ACK. For example, the base station configures, for the UE, 2 serving cells to transmit HARQ-ACK, i.e., a serving cell 1 and a serving cell 1. The indication field of the serving cell is 1 bit. When the indication field value of the serving cell is “0”, the PUCCH resources for transmitting HARQ-ACK are on the serving cell 1; and, when the indication field value of the serving cell is “1”, the PUCCH resources for transmitting HARQ-ACK is on the serving cell 2.

The DCI formats (e.g., DCI format 1-0) in some PDCCHs for scheduling PDSCHs do not contain the indication field of the serving cell. When the PDSCH for transmitting HARQ-ACK in one slot is scheduled by the DCI that does not contain the indication field of the serving cell, the PUCCH for transmitting HARQ-ACK is on a preset serving cell (a specified serving cell). For example, PUCCH resources for transmitting HARQ-ACK are on the primary cell (Pcell) of the UE.

When the HARQ-ACK of some PDSCHs scheduled by the DCI that does not contain the indication field of the serving cell and the HARQ-ACK of some PDSCHs scheduled by the DCI that contains the indication field of the serving cell are transmitted on PUCCH resources overlapped in time, there is a problem how to determine PUCCH resources. The communication method provided in the embodiment of the disclosure just provides a solution to this problem. Two optional embodiments of this method will be described below with reference to the following method 1 and method 2.

### Embodiment 1

When the HARQ-ACK of some PDSCHs scheduled by the DCI that does not contain the indication field of the serving cell and the HARQ-ACK of some PDSCHs scheduled by the DCI that contains the indication field of the serving cell are transmitted on overlapped PUCCHs, the PUCCH resources are indicated by a PUCCH resource indication (PRI) of the last DCI (i.e., the last received DCI) for scheduling PDSCHs that contains the indication field of the serving cell, that is, the PUCCH resources indicated by the PRI of the last DCI are used to transmit the HARQ-ACK of PDSCHs scheduled by the DCI that does not contain the indication field of the serving cell and the HARQ-ACK of some PDSCHs scheduled by the DCI that contains the indication field of the serving cell.

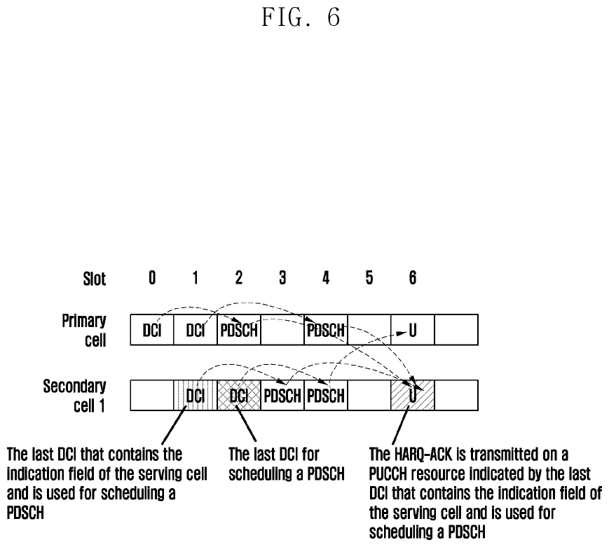

FIG. 6 is a schematic diagram of determining PUCCH resources according to an example of the disclosure. In the example shown in FIG. 6, each rectangular box represents one time unit (e.g., slot), and the primary cell and the secondary cell 1 are serving cells that are configured by the base station and can be used by the UE to transmit UCI. The arrow between the DCI and the PDSCH represents the slot where the PDSCH scheduled by the DCI is located, and the arrow between the PDSCH and the “U” represents the slot where the PUCCH resource for transmitting the HARQ-ACK of the PDSCH is located. For example, the PDSCH scheduled by the DCI of the slot 0 of the primary cell (i.e., the DCI received in the slot 0 of the primary cell) is in the slot 2 of the primary cell, and the PUCCH resource for transmitting the HARQ-ACK of the PDSCH is in the slot 6 of the secondary cell 1. As shown in FIG. 6, in this example, the PUCCH resource for transmitting the HARQ-ACK of the PDSCH scheduled by the DCI in the slot 0 of the primary cell, the PUCCH resource for transmitting the HARQ-ACK of the PDSCH scheduled by the DCI in the slot 1 of the primary cell and the PUCCH resource for transmitting the HARQ-ACK of the PDSCH scheduled by the DCI in the slot 1 of the secondary cell 1 are all in the slot 6 of the secondary cell 1, the PUCCH resource for transmitting the HARQ-ACK of the PDSCH scheduled by the DCI in the slot 2 of the secondary cell 1 is in the slot 6 of the primary cell, and the PUCCH resources for transmitting the HARQ-ACK of PDSCHs scheduled by the four DCIs are located on two serving cells and overlapped in time domain.

In this example, the DCI in the slot 2 of the secondary cell 1 in the four DCIs is the last DCI for scheduling the PDSCH, but the DCI does not contain the indication field of the serving cell; and, the DCI in the slot 1 of the secondary cell 1 is the last DCI for scheduling the PDSCH that contain the indication field of the serving cell. At this time, the HARQ-ACK of the PDSCH scheduled by the DCI in the slot 0 of the primary cell, the HARQ-ACK of the PDSCH scheduled by the DCI in the slot 1 of the primary cell, the HARQ-ACK of the PDSCH scheduled by the DCI in the slot 1 of the secondary cell 1 and the HARQ-ACK of the PDSCH scheduled by the DCI in the slot 2 of the secondary cell 1 are all transmitted on the PUCCH indicated by the PRI in the DCI in the slot 1 of the secondary cell 1. The advantage of this method is that the serving cells of PUCCHs for transmitting HARQ-ACK can be flexibly indicated by the base station through the indication field of the serving cell in the DCI.

### Embodiment 2

When the HARQ-ACK of some PDSCHs scheduled by the DCI that does not contain the indication field of the serving cell and the HARQ-ACK of some PDSCHs scheduled by the DCI that contains the indication field of the serving cell are transmitted on overlapped PUCCHs, the PUCCH resources can be indicated by a PUCCH resource indication (PRI) of the last DCI for scheduling PDSCHs. The PUCCH resources indicated by the PRI of the last DCI are used to transmit the HARQ-ACK of PDSCHs scheduled by the DCI that does not contain the indication field of the serving cell and the HARQ-ACK of some PDSCHs scheduled by the DCI that contains the indication field of the serving cell.

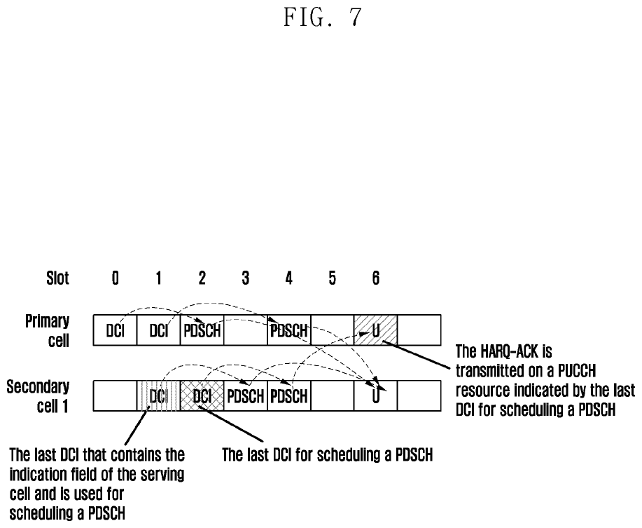

FIG. 7 is a schematic diagram of determining PUCCH resources according to another example of the disclosure. In the example shown in FIG. 7, the DCI in the slot 2 of the secondary cell 1 is the last DCI in the four DCIs for scheduling PDSCHs. At this time, the HARQ-ACK of the PDSCH scheduled by the DCI in the slot 0 of the primary cell, the HARQ-ACK of the PDSCH scheduled by the DCI in the slot 1 of the primary cell, the HAEQ-ACK of the PDSCH scheduled by the DCI in the slot 1 of the secondary cell 1 and the HARQ-ACK of the PDSCH scheduled by the DCI in the slot 2 of the secondary cell are all transmitted on the PUCCH resource indicated by the PRI in the DCI in the slot 2 of the secondary cell. The advantage of this method is that the PUCCH resources for transmitting HARQ-ACK are indicated by the base station in the last time, so that the PUCCH resources can be better selected.

In one optional embodiment of the disclosure, if the specified DCI is a first type of DCI, the first type of DCI is DCI not containing the first indication information for indicating serving cells where PUCCH resources for transmitting UCI are located, or the first type of DCI is DCI containing the first indication information.

That is, the specified DCI may be DCI containing the first indication information, or may be DCI not containing the first indication information.

In one optional embodiment of the disclosure, the method may further comprise at least one of the following:
controlling, according to a transmission power control (TPC) command included in the first type of DCI, the transmission power of a PUCCH for transmitting the UCI of the PDSCH scheduled by the DCI;
not applying a TPC command included in a non-first type of DCI to the power control of a PUCCH for transmitting the UCI of the PDSCH scheduled by the DCI, or applying a TPC command included in a non-first type of DCI to the power control of a PUCCH in a later time of the serving cell where the PUCCH resource for transmitting the UCI indicated by the DCI is located, the later time being a time unit later than the time unit where the PUCCH resource indicated by the DCI is located; and
for a non-first type of DCI, if there is a first type of DCI received before receiving the DCI in the at least two DCIs, controlling the power of a PUCCH for transmitting the UCI of the PDSCH scheduled by the DCI according to the TPC command included in the DCI; and if there is no first type of DCI received before receiving the DCI in the at least two DCIs, not applying the TPC command included in the DCI to the power control of a PUCCH for transmitting the UCI of the PDSCH scheduled by the DCI, or applying it to the power control of a PUCCH in a later time of the serving cell where the PUCCH resource for transmitting the UCI corresponding to the DCI is located.

The above “before” refers to before in the time-frequency domain. If two DCIs are two DCIs received in a same time unit, a previous DCI and a subsequent DCI in frequency domain can be determined according to the frequency domain. For example, for DCI in the slot1 of the primary cell and the slot1 of the secondary cell, the DCI received previously is determined according to the frequency domain corresponding to the two DCIs.

If the first type of DCI is DCI not containing the first indication information, i.e., DCI not containing the indication field of the serving cell (used for indicating the serving cell where the PUCCH resource for transmitting UCI is located), the TPC command included in each DCI not including the first indication information in the at least two DCIs can be applied to the power control of the PUCCH for transmitting the UCI of the PDSCH scheduled by the DCI. For each DCI (i.e., DCI including the indication field of the serving cell) that is not of this type in the at least two DCIs, the TPC command in the DCI can be applied in any one of the following ways.
\textcircled{1} The TPC command in the DCI may not be applied to the power control of the PUCCH for transmitting the UCI of the PDSCH scheduled by the DCI.

\textcircled{2} The TPC command in the DCI may be applied to the power control of a PUCCH in a later time of the serving cell indicated by the DCI (i.e., the serving cell indicated by the indication field of the serving cell in the DCI).

\textcircled{3} If there is a DCI not including the first indication information received before receiving the DCI in the at least two DCIs, the TPC command in the DCI is applied to the power control of the PUCCH for transmitting the UCI of the PDSCH scheduled by the DCI.

\textcircled{4} If there is no DCI not including the first indication information received before receiving the DCI in the at least two DCIs, the TPC command in the DCI is not applied to the power control of the PUCCH for transmitting the UCI of the PDSCH scheduled by the DCI.

\textcircled{5} If there is no DCI not including the first indication information received before receiving the DCI in the at least two DCIs, the TPC command in the DCI is applied to the power control of a PUCCH in a later time of the serving cell indicated by the DCI.

Similarly, the specified DCI is DCI containing the first indication information, the TPC command included in each DCI including the first indication information in the at least two DCIs can be applied to the power control of the PUCCH for transmitting the UCI of the PDSCH scheduled by the DCI. For each DCI not including the first indication information in the at least two DCIs, the TPC command in the DCI can be applied in any one of the following ways.

\textcircled{1} The TPC command in the DCI may not be applied to the power control of the PUCCH for transmitting the UCI of the PDSCH scheduled by the DCI.

\textcircled{2} The TPC command in the DCI may be applied to the power control of a PUCCH in a later time of the serving cell indicated by the DCI (since the DCI is DCI not containing the indicating field of the serving cell, the serving cell indicated by the DCI is a preset serving cell).

\textcircled{3} If there is a DCI including the first indication information received before receiving the DCI in the at least two DCIs, the TPC command in the DCI is applied to the power control of the PUCCH for transmitting the UCI of the PDSCH scheduled by the DCI.

\textcircled{4} If there is no DCI including the first indication information received before receiving the DCI in the at least two DCIs, the TPC command in the DCI is not applied to the power control of the PUCCH for transmitting the UCI of the PDSCH scheduled by the DCI.

\textcircled{5} If there is no DCI including the first indication information received before receiving the DCI in the at least two DCIs, the TPC command in the DCI is applied to the power control of a PUCCH in a later time of the serving cell indicated by the DCI.

For the way \textcircled{1}, the base station and the UE can be prevented from confusing the serving cells using the PTC due to the loss of the DCI for scheduling PDSCHs; for the way \textcircled{2}, the base station and the UE can be prevented from confusing the serving cells using the PTC due to the loss of the DCI for scheduling PDSCHs, and the power adjustment of the PUCCH can be more accurate by fully utilizing the TPC command; and, for the ways \textcircled{3} to \textcircled{5}, the TPC command can be applied to the control power of the PUCCH as much as possible, so as to adjust the power as timely as possible.

In the optional embodiment of the disclosure, the method of applying the TPC command in the DCI for scheduling PDSCHs, i.e., the method of controlling the power of the PUCCH for transmitting UCI, is provided. The power control method will be exemplarily described below by several optional implementations by taking the UCI being HARQ-ACK as an example.

### Embodiment 1

When the HARQ-ACK of some PDSCHs scheduled by DCI not containing the indication field of the serving cell and the HARQ-ACK of some PDSCHs scheduling by DCI containing the indication field of the serving cell are transmitted on overlapped PUCCHs (of course, it is also possible that the HARQ-ACK of some PDSCHs scheduled by DCI not containing the indication field of the serving cell is transmitted on overlapped PUCCHs or the HARQ-ACK of some PDSCHs scheduled by DCI containing the indication field of the serving cell is transmitted on overlapped PUCCHs), if the HARQ-ACK of PDSCHs scheduled by DCI not containing the indication field of the serving cell and the HARQ-ACK of some PDSCHs scheduled by DCI containing the indication field of the serving cell are transmitted on PUCCH resources indicated by the DCI not containing the indication field of the serving cell, optionally, the TPC commands in all DCI not containing the indication field of the serving cell are applied to the power control of the PUCCH for transmitting HARQ-ACK, and the TPC commands in all DCI containing the indication field of the serving cell are not applied to the power control of the PUCCH for transmitting HARQ-ACK.

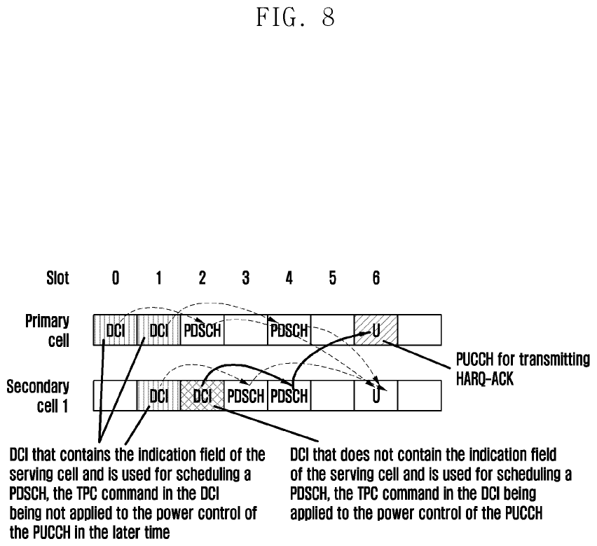

FIG. 8 is an example of a schematic diagram of a method for using a transmission power control (TPC) command in DCI used for scheduling PDSCHs according to an embodiment of the disclosure. In the example shown in FIG. 8, the primary cell and the serving cell are two serving cells of the UE. The DCI in the slot 0 of the primary cell, the DCI in the slot 1 of the primary cell and the DCI in the slot 0 of the secondary cell are DCI containing the first indication information, while the DCI in the slot 2 of the secondary cell is DCI not containing the first indication information. The PUCCH resources indicated by the DCI in the slot 2 of the secondary cell (i.e., resources belonging to the slot 6 of the primary cell in time domain) are used to transmit the HARQ-ACK of PDSCHs scheduled by the four DCIs (i.e., PUCCHs for transmitting HARQ-ACK shown in this figure). The TPC commands in the DCI containing the first indication information in the slot 0 of the primary cell, the DCI containing the first indication information in the slot 1 of the primary cell and the DCI containing the first indication information in the slot 0 of the secondary cell are not applied to the power control of the PUCCHs indicated by respective DCI, and the TPC command in the DCI in the slot 2 of the secondary cell is applied to the power control the PUCCH indicated by the DCI.

### Embodiment 2

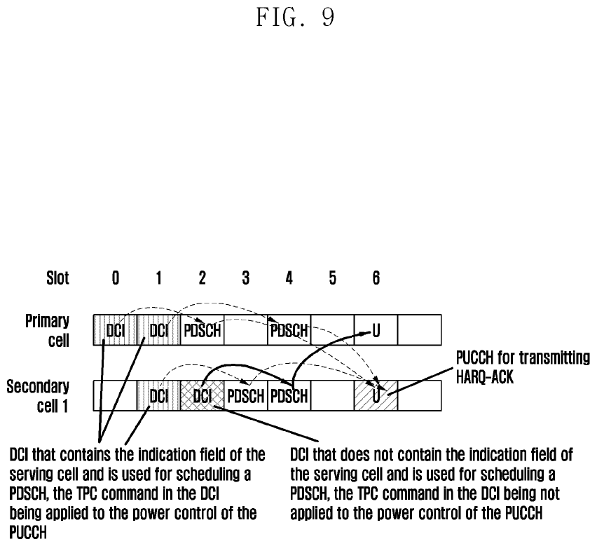

If the HARQ-ACK of PDSCHs scheduled by DCI not containing the indication field of the serving cell and the HARQ-ACK of some PDSCHs scheduled by DCI containing the indication field of the serving cell are transmitted PUCCH resources by the DCI containing the indication field of the serving cell (in the example shown in FIG. 6), the TPC commands in all DCI containing the indication field of the serving cell are applied to the power control of the PUCCHs for transmitting HARQ-ACK, and the TPC commands in all DCI not containing the indication field of the serving cell are not applied to the power control of the PUCCHs for transmitting HARQ-ACK. FIG. 9 is another example of a schematic diagram of a method for using a TPC command in DCI used for scheduling PDSCHs according to an embodiment of the disclosure. In the example shown in FIG. 9, the PUCCH resources indicated by the four DCIs are resources that are located on two serving cells and overlapped in time domain (the slot 6 shown in this figure). The DCI in the slot0 of the primary cell, the DCI in the slot1 of the primary cell and the DCI in the slot1 of the secondary cell 1 are DCI containing the first indication information (i.e., the indication field for indicating the serving cell), and the TPC commands in the three DCIs can be applied to the power control of the PUCCH. The DCI in the slot2 of the secondary cell 1 is DCI not containing the first indication information, and the TPC command in the DCI is not applied to the power control of the PUCCH.

By using the method in the Embodiment 1 or Embodiment 2, the base station and the UE can be prevented from confusing the serving cells using TPC due to the loss of the DCI for scheduling PDSCHs.

### Embodiment 3

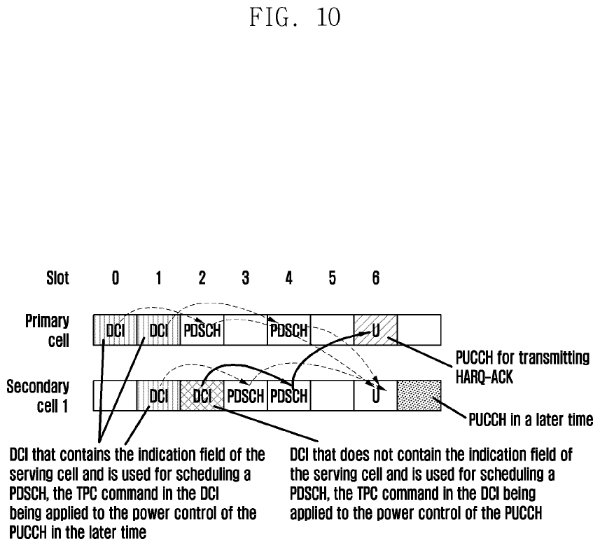

When the HARQ-ACK of some PDSCHs scheduled by DCI not containing the indication field of the serving cell and the HARQ-ACK of some PDSCHs scheduled by DCI containing the indication field of the serving cell are transmitted on overlapped PUCCHs, if the HARQ-ACK of PDSCHs scheduled by DCI not containing the indication field of the serving cell and the HARQ-ACK of some PDSCHs scheduled by DCI containing the indication field of the serving cell are transmitted on PUCCH resources indicated by the DCI not containing the indication field of the serving cell, the TPC commands in all DCI not containing the indication field of the serving cell are applied to the power control of the PUCCH for transmitting HARQ-ACK, and the TPC commands in all DCI containing the indication field of the serving cell are applied to the power control of a PUCCH in a later time of the serving cell indicated by the DCI. FIG. 10 is another example of a schematic diagram of a method for using a TPC command in DCI used for scheduling PDSCHs according to an embodiment of the disclosure. In the example shown in FIG. 10, the DCI in the slot0 of the primary cell, the DCI in the slot1 of the primary cell and the DCI in the slot1 of the secondary cell 1 are DCI containing the indication field of the serving cell, and the TPC commands in these DCIs can be applied to the power control of a PUCCH in a later time of the serving cell indicated by the DCI. For the DCI in the slot1 of the secondary cell 1, the PUCCH resource indicated by the DCI is the resource in the slot6 of the secondary cell 1, and the TPC command in the DCI can be applied to the power control of a PUCCH in a time after the slot6 of the secondary cell 1.

### Embodiment 4

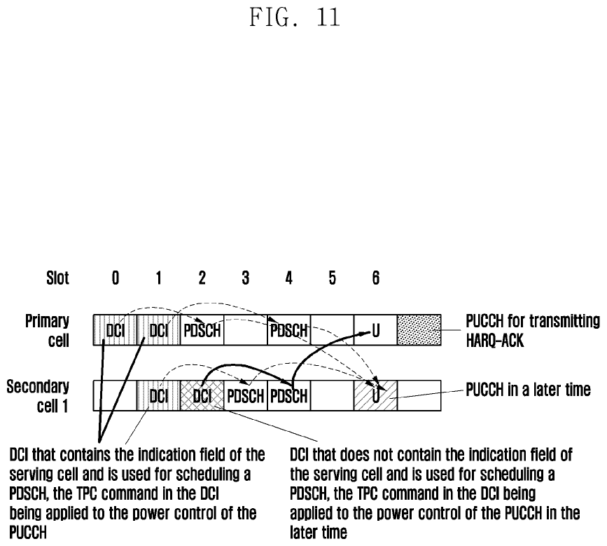

When the HARQ-ACK of some PDSCHs scheduled by DCI not containing the indication field of the serving cell and the HARQ-ACK of some PDSCHs scheduled by DCI containing the indication field of the serving cell are transmitted on overlapped PUCCHs, if the HARQ-ACK of PDSCHs scheduled by DCI not containing the indication field of the serving cell and the HARQ-ACK of some PDSCHs scheduled by DCI containing the indication field of the serving cell are transmitted on PUCCH resources indicated by the DCI containing the indication field of the serving cell, the TPC commands in all DCI containing the indication field of the serving cell are applied to the power control of the PUCCH for transmitting HARQ-ACK, and the TPC commands in all DCI not containing the indication field of the serving cell are applied to the power control of a PUCCH in a later time of the serving cell indicated by the DCI. FIG. 11 is another example of a schematic diagram of a method for using a TPC command in DCI used for scheduling PDSCHs according to an embodiment of the disclosure. In the example shown in FIG. 11, the DCI in the slot2 of the secondary cell 1 is DCI not containing the indication field of the serving cell, the PUCCH resource indicated by the DCI is the resource in the slot6 of the primary cell, and the TPC command in the DCI can be applied to the power control of a PUCCH after the slot6 of the primary cell.

By using the method in the Embodiment 3 or Embodiment 4, the base station and the UE can be prevented from confusing the serving cells using TPC due to the loss of the DCI for scheduling PDSCHs, and the power adjustment of PUCCHs can be more accurate by fully utilizing the transmitted TPC command.

### Embodiment 5

When the HARQ-ACK of some PDSCHs scheduled by DCI not containing the indication field of the serving cell and the HARQ-ACK of some PDSCHs scheduled by DCI containing the indication field of the serving cell are transmitted on overlapped PUCCHs, if the HARQ-ACK of PDSCHs scheduled by DCI not containing the indication field of the serving cell and the HARQ-ACK of some PDSCHs scheduled by DCI containing the indication field of the serving cell are transmitted on PUCCH resources indicated by the DCI not containing the indication field of the serving cell, the TPC commands in all DCI not containing the indication field of the serving cell are applied to the power control of the PUCCH for transmitting HARQ-ACK. If there is DCI not containing the indication field of the serving cell before the TPC command in the DCI containing the indication field of the serving cell, the TPC command in the DCI is applied to the power control of the PUCCH for transmitting HARQ-ACK. If there is no DCI not containing the indication field of the serving cell before the TPC command in the DCI containing the indication field of the serving cell, the TPC command in the DCI is not applied to the power control of the PUCCH for transmitting HARQ-ACK.

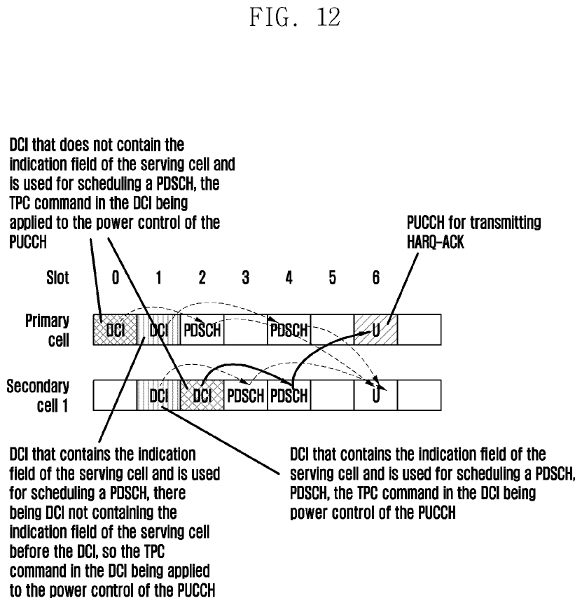

FIG. 12 is another example of a schematic diagram of a method for using a TPC command in DCI used for scheduling PDSCHs according to an embodiment of the disclosure. In the example shown in FIG. 12, the DCI in the slot2 of the secondary cell 1 and the DCI in the slot0 of the primary cell are DCI not containing the indication field of the serving cell, and the DCI in the slot1 of the secondary cell 1 and the DCI in the slot 1 of the primary cell are DCI containing the indication field of the serving cell. The PUCCH resources for transmitting the HARQ-ACK of the PDSCHs scheduled by the shown four DCIs are PUCCH resources indicated by the DCI in the slot2 of the primary cell 1, i.e., PUCCH resources in the slot6 of the primary cell. In this example, the TPC command in the DCI in the slot2 of the secondary cell 1 and the TPC command in the DCI in the slot1 of the primary cell are applied to the power control of the PUCCH. If there is DCI not containing the indication field of the serving cell (i.e., DCI in the slot0 of the primary cell) before the DCI in the slot1 of the primary cell, the TPC command in the DCI is applied to the power control of the PUCCH. If there is DCI not containing the indication field of the serving cell (i.e., DCI in the slot0 of the primary cell) before the DCI in the slot1 of the secondary cell 1, the DCI in the slot1 of the secondary cell 1 is applied to the power control of the PUCCH.

### Embodiment 6

When the HARQ-ACK of some PDSCHs scheduled by DCI not containing the indication field of the serving cell and the HARQ-ACK of some PDSCHs scheduled by DCI containing the indication field of the serving cell are transmitted on overlapped PUCCHs, if the HARQ-ACK of PDSCHs scheduled by DCI not containing the indication field of the serving cell and the HARQ-ACK of some PDSCHs scheduled by DCI containing the indication field of the serving cell are transmitted on PUCCH resources indicated by the DCI containing the indication field of the serving cell, the TPC commands in all DCI containing the indication field of the serving cell are applied to the power control of the PUCCH for transmitting HARQ-ACK. If there is DCI containing the indication field of the serving cell before the TPC command in the DCI not containing the indication field of the serving cell, the TPC command in the DCI is applied to the power control of the PUCCH for transmitting HARQ-ACK. If there is no DCI not containing the indication field of the serving cell before the TPC command in the DCI not containing the indication field of the serving cell, the TPC command in the DCI is not applied to the power control of the PUCCH for transmitting HARQ-ACK.

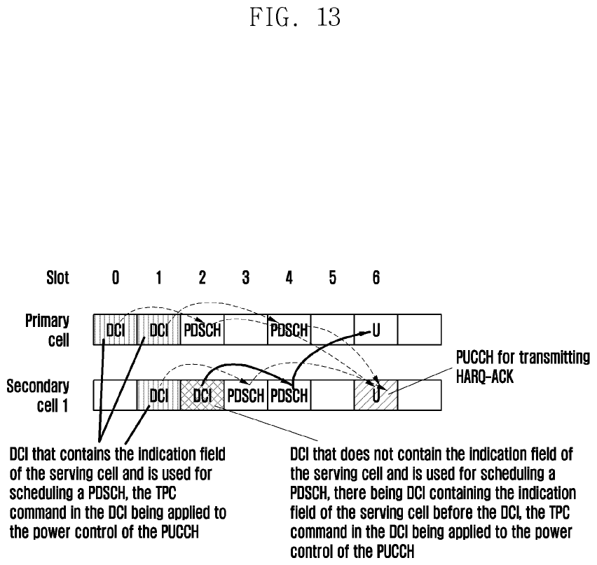

FIG. 13 is another example of a schematic diagram of a method for using a TPC command in DCI used for scheduling PDSCHs according to an embodiment of the disclosure. In the example shown in FIG. 13, the DCI in the slot2 of the secondary cell 1 is DCI not containing the indication field of the serving cell, and the DCI in the slot1 of the secondary cell 1, the DCI in the slot1 of the primary cell and the DCI in the slot1 of the primary cell are DCI containing the indication field of the serving cell. It is assumed that the PUCCH resources for transmitting the HARQ-ACK of PDSCHs scheduled by the shown four DCIs are PUCCH resources indicated by the DCI containing the indication field of the serving cell, i.e., PUCCH resources in the shown slot6 of the primary cell. In this example, if there is DCI containing the indication field of the serving cell (DCI in the slot1 of the secondary cell 1) before the DCI in the slot2 of the secondary cell 1, the TPC command in the DCI in the slot2 of the secondary cell 1 can be applied to the power control of the PUCCH.

### Embodiment 7

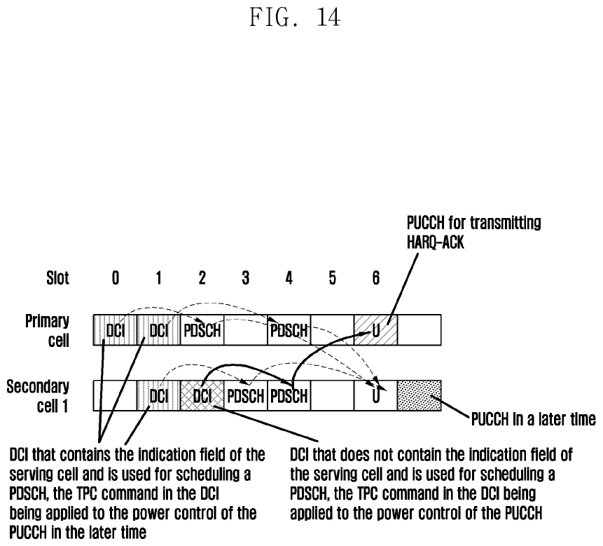

When the HARQ-ACK of some PDSCHs scheduled by DCI not containing the indication field of the serving cell and the HARQ-ACK of some PDSCHs scheduled by DCI containing the indication field of the serving cell are transmitted on overlapped PUCCHs, if the HARQ-ACK of PDSCHs scheduled by DCI not containing the indication field of the serving cell and the HARQ-ACK of some PDSCHs scheduled by DCI containing the indication field of the serving cell are transmitted on the PUCCH resources indicated by the DCI not containing the indication field of the serving cell, the TPC commands in all DCI not containing the indication field of the serving cell are applied to the power control of the PUCCH for transmitting HARQ-ACK. If there is DCI not containing the indication field of the serving cell before the TPC command in the DCI containing the indication field of the serving cell, the TPC command in the DCI is applied to the power control of the PUCCH for transmitting HARQ-ACK. If there is no DCI not containing the indication field of the serving cell before the TPC command in the DCI containing the indication field of the serving cell, the TPC command in the DCI is applied to the power control of a PUCCH in a later time after the serving cell indicated by the DCI. FIG. 14 is another example of a schematic diagram of a method for using a TPC command in DCI used for scheduling PDSCHs according to an embodiment of the disclosure. In the example shown in FIG. 14, the PUCCH resources for transmitting the HARQ-ACK of PDSCHs scheduled by the shown four DCIs are PUCCH resources indicated by the DCI in the slot2 of the secondary cell 1 (i.e., the DCI not containing the indication field of the serving cell), i.e., PUCCH resources in the slot6 of the primary cell. Since there is no DCI not containing the indication field of the serving cell before other three DCIs containing the indication field of the serving cell, the TPC commands in the three DCIs can be applied to the power control of a PUCCH in a later time of the serving cell indicated by the DCI.

### Embodiment 8

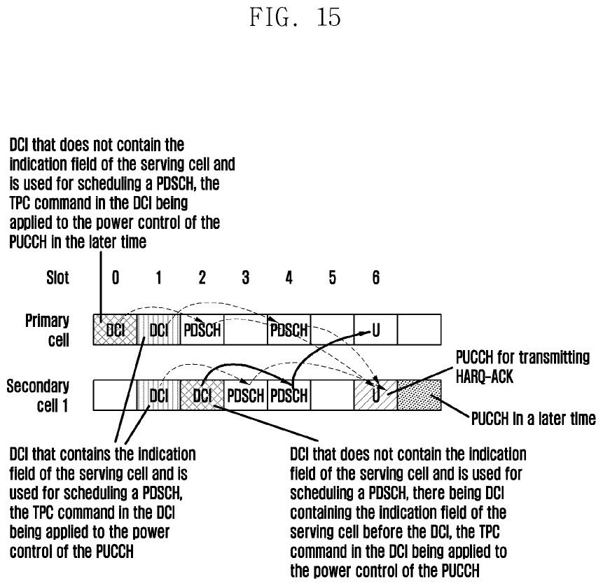

When the HARQ-ACK of some PDSCHs scheduled by DCI not containing the indication field of the serving cell and the HARQ-ACK of some PDSCHs scheduled by DCI containing the indication field of the serving cell are transmitted on overlapped PUCCHs, if the HARQ-ACK of PDSCHs scheduled by DCI not containing the indication field of the serving cell and the HARQ-ACK of some PDSCHs scheduled by DCI containing the indication field of the serving cell are transmitted on the PUCCH resources indicated by the DCI containing the indication field of the serving cell, the TPC commands in all DCI containing the indication field of the serving cell are applied to the power control of the PUCCH for transmitting HARQ-ACK. If there is DCI containing the indication field of the serving cell before the TPC command in the DCI not containing the indication field of the serving cell, the TPC command in the DCI is applied to the power control of the PUCCH for transmitting HARQ-ACK. If there is no DCI containing the indication field of the serving cell before the TPC command in the DCI not containing the indication field of the serving cell, the TPC command in the DCI is applied to the power control of a PUCCH in a later time after the serving cell indicated by the DCI. FIG. 15 is another example of a schematic diagram of a method for using a TPC command in DCI used for scheduling PDSCHs according to an embodiment of the disclosure. In the example shown in FIG. 15, the PUCCH resources for transmitting the HARQ-ACK of PDSCHs scheduled by the shown four DCIs are PUCCH resources indicated by the DCI in the slot1 of the secondary cell (i.e., the DCI containing the indication field of the serving cell), i.e., PUCCH resources in the slot6 of the secondary cell 1. If there is no DCI containing the indication field of the serving cell before the DCI in the slot0 of the primary cell, the DCI can be applied to the power control of a PUCCH in a later time of the secondary cell 1 (the preset/specified serving cell or the serving cell indicated by the base station in other ways) indicated by the DCI. If there is DCI containing the indication field of the serving cell before the DCI in the slot2 of the secondary cell, the DCI can be applied to the power control of the PUCCH for transmitting the HARQ-ACK of the PDSCH scheduled by the DCI.

By using the solutions provided in the Embodiments 5 to 8, the transmission power of the PUCCH can be timely adjusted by applying the TPC command as far as possible.

In the foregoing embodiments of the disclosure, multiple optional methods of applying the TPC command in the DCI for scheduling PDSCHs are provided. In the wireless communication system, except that the DCI for scheduling PDSCHs may comprise a TPC command for controlling the transmission power of PUCCHs, the DCI not for scheduling PDSCHs (also called group common DCI, e.g., DCI format 2_2) may also comprise a TPC command. In the embodiments of the disclosure, a method of applying the TPC command in the group common DCI during UCI transmission is also provided. The method of applying the TPC command in the group common DCI will be described below. When the UCI (e.g., HARQ-ACK) of PDSCHs of serving cells in a serving cell group can be transmitted in uplink slots of more than one serving cell among the serving cells, optionally, in any time unit (e.g., slot), the UCI of the PDSCHs of the serving cells in the serving cell group are only transmitted in one serving cell. For example, in one slot, the UE only performs transmission in one serving cell in this serving cell group. The solution how to apply the TPC command in the group common DCI in this scenario will be described below.

In one optional embodiment of the disclosure, the method further comprises:
receiving group common DCI, the group common DCI containing second indication information used for indicating a serving cell to which a TPC command in the group common DCI is applied;
determining, according to the second indication information, the serving cell to which the TPC command in the group common DCI is applied; and
for the received DCI for scheduling a PDSCH, if the serving cell where the PUCCH resource for transmitting the UCI of the PDSCH scheduled by the DCI is located is the serving cell indicated by the second indication information, applying the TPC command included in the group common DCI to the power control of the PUCCH for transmitting the UCI of the PDSCH scheduled by the DCI.

The group command DCI is group common DCI which can transmit the TPC command of the PUCCH, e.g., DCI format 2_2.

When the UCI of PDSCHs of serving cells in a serving cell group can be transmitted in uplink slots of more than one (one or more) serving cell in the serving cell group, a new indication field (i.e., second indication information) can be added in the group common DCI. The name of the indication field is not limited in the embodiments of the disclosure. For example, the indication field is called a cell power control indicator field, or may have other names. For a UE, the indication field may be added to a field corresponding to the UE in the group common DCI, and the indication field may be used to indicate the serving cell of the UE to which the TPC command in the group common DCI is applied. If the UE detects the group common DCI in the PDCCH and when the serving cell indicated by the indication field in the group common DCI (i.e., the serving cell to which the TPC command in the DCI is applied) is a serving cell where the PUCCH resource for transmitting the UCI of a PDSCH of a serving cell in the serving cell group of the UE is located, the TPC field in the group common DCI can be applied to the control of the transmission power of the PUCCH for transmitting the UCI of the serving cell.

Based on this solution, the UE can transmit UCI on PUCCH resources of one or more serving cells in the serving cell group. In this scenario, when the UE receives the DCI for scheduling the PDSCH of the serving cell in the serving cell group, if the serving cell where the PUCCH resource for transmitting the UCI of the PDSCH scheduled by the DCI is located (i.e., the serving cell for transmitting the UCI of the PDSCH) is the same the serving cell indicated by the indication field in the received group common DCI (i.e., the serving cell to which the TPC is applied), the TPC command in the group common DCI is applied to the control of the transmission power of the PUCCH of the serving cell. If the cell where the PUCCH resource for transmitting the UCI of the PDSCH is located is different from the serving cell corresponding to the indication field, the TPC is not applied to the power control of the PUCCH.

Optionally, the group common DCI may be DCI format 2_2, and the indication field (i.e., the second indication information) may be added in the existing DCI format 2_2. Optionally, the group common DCI may also be newly defined DCI.

In one optional embodiment of the disclosure, the group common DCI may further comprise third indication information for indicating a power control adjustment state of the PUCCH for transmitting the UCI in the serving cell indicated by the second indication information; and, if the serving cell where the PUCCH resource for transmitting the UCI of the PDSCH scheduled by the DCI is located is the serving cell indicated by the second indication information, the method further comprises:

determining, according to the power control adjustment state indicated by the third indication information, the transmission power of the PUCCH for transmitting the UCI of the PDSCH scheduled by the DCI.

That is, the group common DCI may further comprise the power control adjustment state (PUCCH-PC-AdjustmentStates) for indicating the used PUCCH. The power control adjustment state is the power control adjustment state of the PUCCH used by the serving cell indicated by the second indication information. If the TPC command in the group command DCI indicated by the second indication information is applied to the serving cell 1, the third indication information is used to indicate the power control adjustment state used by the serving cell 1. Of course, in practical applications, if there is only one set of power control adjustment states for each of more than one serving cell capable of transmitting UCI in a serving cell group, the group common DCI may not contain the third indication information. That is, the number of bits of the third indication information in the group common DCI can be determined according to the number of power control adjustment states of each serving cell capable of transmitting UCI in a serving cell group.

In one optional embodiment of the disclosure, the number of bits of the third indication information is determined according to a first numerical value. The first numerical value is the largest value among a plurality of second numerical values, and the plurality of second numerical values is the number of power control adjustment states of each serving cell in at least one serving cell, in the serving cell group of the UE, which is capable of transmitting UCI of the serving cell group.

Optionally, if it is assumed that there are two serving cells capable of transmitting UCI in a serving cell group (one serving cell is configured with two sets of power control adjustment states and the other serving cell is configured with one set of power control adjustment states), the number of bits of the third indication information may be represented as: up-rounding (log 2(M)), where M is a larger value in the number of configured power control adjustment states. In the example, if M is 2, the number of bits of the third indication information is 1; and, if the number of power control adjustment states configured for each of the two serving cells is 1, the number of bits of the third indication information 0. That is, at this time, the group common DCI may not contain the third indication information. Similarly, the name of the third indication information is not limited in the embodiments of the disclosure. For example, the third indication information may be called closed loop indication/indicator field/information, or may have other names such as closed loop power control adjustment indicator.

In one embodiment of the disclosure, the second indication information is used to jointly indicate the serving cell to which the TPC command in the group common DCI is applied and the power control adjustment state of the PUCCH for transmitting the UCI in the serving cell; and, if the serving cell where the PUCCH resource for transmitting the UCI of the PDSCH scheduled by the DCI is located is the serving cell indicated by the second indication information, the method further comprises:

determining, according to the power control adjustment state indicated by the second indication information, the transmission power of the PUCCH for transmitting the UCI of the PDSCH scheduled by the DCI.

That is, the third indication information may be a joint indication field for jointly indicating the serving cell to which the TPC command in the group common DCI is applied and the power control adjustment state used by the serving cell.

In one optional embodiment of the disclosure, when the second indication information is used to jointly indicate the serving cell to which the TPC command in the group common DCI is applied and the power control adjustment state used by the PUCCH for transmitting UCI in the serving cell, the number of bits of the second indication information is determined according to a third numerical value, and the third numerical value is the sum of the plurality of second numerical values.

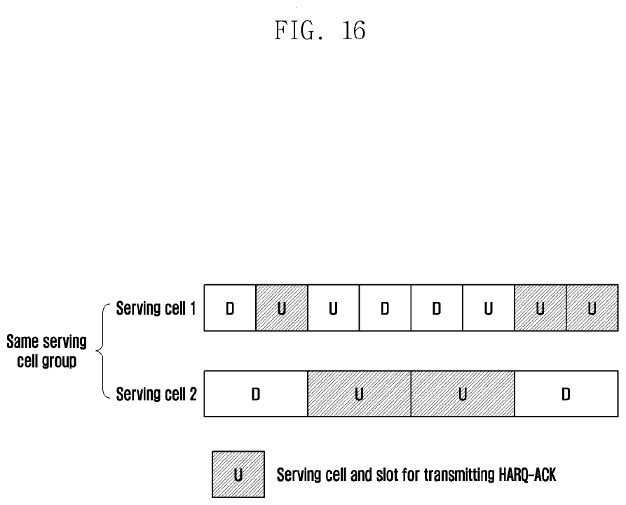

The method of applying the TPC command in the DCI not for scheduling PDSCHs (also called group common DCI, e.g., DCI format 2_2) will be described by specific optional embodiments. The HARQ-ACK of PDSCHs of serving cells in a serving cell group can be transmitted in uplink slots of more than one serving cell in the serving cell group (optionally, it is only transmitted in one serving cell in any slot). FIG. 16 is a schematic diagram of a situation where UCI in a serving cell group of a UE can be transmitted in uplink slots of a plurality of serving cells in the serving cell group, according to an embodiment of the disclosure. In the example shown in FIG. 16, the serving cell 1 and the serving cell 2 are serving cells in a same serving cell group, and the HARQ-ACK of PDSCHs of serving cells in this serving cell group can be transmitted in uplink slots of the serving cell 1 and the serving cell 2. That is, the two serving cells are serving cells capable of transmitting UCI in this serving cell group.

### Embodiment 1

The HARQ-ACK of PDSCHs of serving cells in a serving cell group can be transmitted in uplink slots of more than one serving cell in this serving cell. Optionally, for a UE that only performs transmission in one serving cell in any slot, a serving cell indication field for indicating the serving cell to which the TPC is applied is added in a field block in the DCI format 2_2 corresponding to the UE. At this time, one field block in the DCI format 2_2 of the UE may contain one or more of the following fields.

### Field 1: Serving Cell Power Control Indicator, i.e., the Second Indication Information

This field is used to indicate the serving cell to which the TPC command in the DCI format 2_2 is applied. The number of bits of this field is determined by the number N of serving cells of PUCCHs configured for the UE by the base station to transmit HARQ-ACK of a serving cell group. Optionally, the number L of bits of the serving cell indication field is obtained by up-rounding (log 2(N)). For example, when N is equal to 2, L is equal to 1. When the serving cell indication value is “0”, the TPC command in the DCI format 2_2 is applied to the power control of the PUCCH of the serving cell 1 for transmitting the HARQ-ACK of this serving cell group; and, when the serving cell indication value is “1”, the TPC command in the DCI format 2_2 is applied to the power control of the PUCCH of the serving cell 2 for transmitting the HARQ-ACK of this serving cell group.

### Field 2: Closed Loop Indicator, i.e., the Third Indication Information

This field is used to indication of the power control adjustment state of a serving cell for transmitting a PUCCH. The number of bits of this field is determined by the number of power control adjustment states in the largest (maximum) number power control adjustment states configured trough a high-layer signaling in serving cells of PUCCHs configured for the UE by the base station to transmit the HARQ-ACK of one serving cell group. Optionally, the number P of bits of the closed loop indicator field is obtained by up-rounding (log 2(M)). For example, the number of serving cells of PUCCHs configured for the UE by the base station to transmit the HARQ-ACK of one serving cell group is 2, i.e., the serving cell 1 and the serving cell 2. The serving cell 1 is configured with 1 set of power control adjustment states (for example, in this serving cell, no signaling parameter twoPUSCH-PC-AdjustmentStates is configured for the UE by the base station), and the serving cell 2 is configured with 2 sets of power control adjustment states (for example, in this serving cell, the signaling parameter twoPUSCH-PC-AdjustmentStates is configured for the UE by the base station). At this time, the largest number M of power control adjustment states configured through a high-layer signaling in serving cells of PUCCHs used by the UE to transmit the HARQ-ACK of one serving cell group is equal to max {the number (1) of power control adjustment states configured for the serving cell 1, the number (2) of power control adjustment states configured for the serving cell 2}=2. The number of bits of the field is determined by the largest power control parameter set number 2 of power control adjustment states configured through the high-layer signaling, that is, P=up-rounding (log 2(M))=up-rounding (log 2(2))=1. At this time, the power control adjustment state of a serving cell for transmitting a PUCCH can be indicated by one bit number. If it is assumed that the serving cell indication value indicates the serving cell 1, the serving cell corresponds to one set of power control adjustment states. At this time, the value of the closed power control indicator may be null or may be other specific values. If the serving cell indication value indicates the serving cell 2, this serving cell corresponds to two sets of power control adjustment states. Optionally, if it is assumed that closed loop indicator is “1”, one set of (e.g., the first set of) power control adjustment states is used; and, if the closed loop indicator is “0”, the other set of power control adjustment states is used.

For another example, the number of serving cells of PUCCHs configured for the UE by the base station to transmit the HARQ-ACK of one serving cell group is 2, i.e., the serving cell 1 and the serving cell 2. The serving cell 1 is configured with 1 set of power control adjustment states (for example, in this serving cell, no signaling parameter twoPUSCH-PC-AdjustmentStates is configured for the UE by the base station), and the serving cell 2 is configured with 1 set of power control adjustment states (for example, in this serving cell, no signaling parameter twoPUSCHPC-AdjustmentStates is configured for the UE by the base station). At this time, the largest number M of power control adjustment states configured through a high-layer signaling in serving cells of PUCCHs used by the UE to transmit the HARQ-ACK of a serving cell group is equal to max {the number (1) of power control adjustment states configured for the serving cell 1, the number (1) of power control adjustment states configured for the serving cell 2}=1. The number of bits of the field is determined by the largest number 1 of power control adjustment states in the number of power control adjustment states configured through the high-layer signaling, that is, P=up-rounding (log 2(1))=up-rounding (log 2(1))=0.

### Field 3: TPC Command

This field can be defined as in the existing standard protocol and will not be repeated here.

### Embodiment 2

The HARQ-ACK of PDSCHs of serving cells in a serving cell group can be transmitted in uplink slots of more than one serving cell in this serving cell; and for a UE that only performs transmission in one serving cell in any slot, a serving cell power control and closed loop joint indication field for indicating the serving cell to which the TPC command is applied and the PUCCH power control adjustment state of this serving cell is added in a field block in the DCI format 2_2 corresponding to the UE. At this time, one field block in the DCI format 2_2 of the UE may contain one or more of the following fields:

### Field 1: Serving Cell Power Control and Closed Loop Joint Indication, i.e., the Second Indication Information for Joint Indication

This field is used to indicate the serving cell for transmitting the PUCCH to which the TPC command in the DCI format 2_2 is applied and the power control adjustment state for transmitting the PUCCH. The number of bits of this field is determined the sum M1+M2+ . . . +Ms of the numbers of power control adjustment states, configured through a high-layer signaling, of all serving cells of PUCCHs configured for the UE by the base station to transmit the HARQ-ACK of one serving cell group, where s the number of serving cells of PUCCHs configured for the UE by the base station to transmit the HARQ-ACK of one serving cell group, and Mi is the number of power control adjustment states of the i^{th} (i=1, 2, . . . , s) serving cell of the PUCCH configured for the UE by the base station to transmit the HARQ-ACK of one serving cell group. Optionally, the number P of bits of the serving cell and closed loop power control joint indication field is obtained by up-rounding (log 2(M1+M2+ . . . +Ms)). For example, the number of serving cells of PUCCHs configured for the UE by the base station to transmit the HARQ-ACK of one serving cell group is 2, i.e., the serving cell 1 and the serving cell 2. The serving cell 1 is configured with 1 set of power control adjustment states (for example, in this serving cell, no signaling parameter twoPUSCHPC-AdjustmentStates is configured for the UE by the base station), and the serving cell 2 is configured with 2 sets of power control adjustment states (for example, in this serving cell, the signaling parameter twoPUSCH-PC-AdjustmentStates is configured for the UE by the base station). At this time, the sum of the numbers of power control adjustment states, configured through the high-layer signaling, of all serving cells of PUCCHs used by the UE to transmit the HARQ-ACK of one serving cell group is M1+M2-1+2-3, and the number of bits of the serving cell and closed loop power control joint indication field is P=up-rounding (log 2(M1+M2))=up-rounding (log 2(1+2))=2. As one optional example, the specific indication mode of the joint indication field can be shown in Table 1.

### [Table 1]

Table 1: Correspondence between the serving cell and closed loop power control joint indication field value and the power control adjustment state

| Serving cell | The serving cell | |
|---|---|---|
| power control | for transmitting | |
| and closed loop | PUCCH to which | |
| joint indication | the TPC command | Power |
| field value | is applied | control adjustment state |
| 00 | Serving cell 1 | Power control adjustment |
| | | state of the serving cell 1 |
| 01 | Serving cell 2 | The first set of power |
| | | control adjustment states |
| | | of the serving cell 2 |
| 10 | Serving cell 2 | The second set of power |
| | | control adjustment states |
| | | of the serving cell 2 |
| 11 | Reserved | Reserved |

### Field 2: TPC Command

This field can be defined as in the existing standard protocol and will not be repeated here.

As described above, in the method provided in the embodiments of the disclosure, the UCI may comprise HARQ-ACK information. When the HARQ-ACK information is fed back in a PUCCH, it is necessary to determine the HARQ-ACK codebook used by transmitting the HARQ-ACK information. When the HARQ-ACK information of PDSCHs of serving cells in a serving cell group can be transmitted in uplink slots of a plurality of serving cells in this serving cell group, an embodiment of the disclosure further provides a method of determining an HARQ-ACK codebook of a type 1. When the base station configures the Type-1 HARQ-ACK codebook for the UE, that is, when pdsch-HARQ-ACK-Codebook=semi-static, the method of determining the HARQ-ACK codebook will be described below.

In one optional embodiment of the disclosure, for the DCI belonging to a serving cell group in the received DCI for scheduling PDSCHs, the static HARQ-ACK codebook used for transmitting the HARQ-ACK of the PDSCH scheduled by the DCI is determined according to an HARQ-ACK timing relation set of a specified serving cell in at least two serving cells capable of transmitting the HARQ-ACK in the serving cell group, or according to a union set of HARQ-ACK timing relation sets of serving cells in at least two serving cells capable of transmitting the HARQ-ACK; or, when sub-carrier spatial configurations of at least two serving cells capable of transmitting the HARQ-ACK in the serving cell group are the same, the HARQ-ACK timing relation sets of the at least two serving cells are a same set.

In other words, for the serving cell group of the UE, if the HARQ-ACK of PDSCHs scheduled by the DCI of serving cells in a serving cell group can be transmitted on one or more serving cells in this serving cell group, and when the UE receives the DCI (DCI for scheduling PDSCHs) of serving cells in this serving cell, the HARQ-ACK timing relation set for determining the static HARQ-ACK codebook may be the HARQ-ACK timing relation set of the specified serving cell in the serving cells capable of transmitting HARQ-ACK in this serving cell group, or may be the union set of the HARQ-ACK timing relation sets corresponding to serving cells in the serving cells capable of transmitting HARQ-ACK.

Optionally, the specified serving cell may be any one of the following:
a serving cell having the largest sub-carrier spatial configuration in the serving cell group;
a serving cell having the smallest sub-carrier spatial configuration in the serving cell group;
a serving cell where the PUCCH resource indicated by the specified DCI is located; or
a primary cell of the UE.

In one optional embodiment of the disclosure, the method may further comprise:
for DCI of a serving cell in a serving cell group, if the HARQ-ACK information of the PDSCH scheduled by the DCI is not transmitted on the specified serving cell and the first sub-carrier spatial configuration of the serving cell where the PUCCH resource for transmitting the HARQ-ACK information of the PDSCH scheduled by the DCI is located is different from the second sub-carrier spatial configuration of the specified serving cell, converting a first indication value in the specified DCI into a second indication value according to the first sub-carrier spatial configuration and the second sub-carrier spatial configuration;
wherein the second indication value is a value in the HARQ-ACK timing relation set of the specified serving cell.

In other words, when the HARQ-ACK timing relation set of the specified serving cell is used as the HARQ-ACK timing relation set for determining the static HARQ-ACK codebook, if the HARQ-ACK timing relation indication value carried in the DCI is a value in the HARQ-AC timing relation set of another serving cell (another serving cell capable of transmitting the HARQ-ACK information of the PDSCH scheduled by the DCI in the serving cell group) and if the sub-carrier spatial configuration of the another serving cell is different from the sub-carrier spatial configuration of the specified serving cell, it is necessary to convert the indication value, and the converted indication value is a time offset value between the PUCCU for indicating the PDSCH and the PUCCH fed back by the corresponding HARQ-ACK information. In this way, the number of HARQ-ACK bits in the Type-1 HARQ-ACK codebook determined by the HARQ-ACK timing relation set of the specified serving cell will not be changed.

In one optional embodiment of the disclosure, if there are at least two sub-carrier spatial configurations among the sub-carrier spatial configurations of serving cells in the at least two serving cells capable of transmitting HARQ-ACK, by using one of the at least two sub-carrier spatial configurations as a reference configuration, the union set is a union set of HARQ-ACK timing relation sets obtained after converting the HARQ-ACK timing relation sets corresponding to other sub-carrier spatial configurations according to the other sub-carrier spatial configurations and the reference configuration and an HARA-ACK timing relation set corresponding to the reference configuration.

If the sub-carrier spatial configurations of the serving cells in at least two serving cells capable of transmitting HARQ-ACK are the same, the union set of the HARQ-ACK timing relation sets corresponding to the serving cells in the at least two serving cell can be directly determined as the HARQ-ACK timing relation set for determining the Type-1 HARQ-ACK codebook; and, if the sub-carrier spatial configurations of the serving cells in the at least two serving cells are at least two different sub-carrier spatial configurations, it is necessary to covert the HARQ-ACK timing relation sets of the serving cells of other sub-carrier spatial configurations by using one sub-carrier spatial configuration as a benchmark configuration (i.e., the reference configuration), and the union set of the converted HARQ-ACK timing relation sets and the benchmark configuration is used as the HARQ-ACK timing relation set for determining the Type-1 HARQ-ACK codebook.

If should be understood that, if the union set is used as the HARQ-ACK timing relation set for determining the Type-1 HARQ-ACK codebook, the UE can determine the Type-1 HARQ-ACK codebook according to the sub-carrier spatial configuration corresponding to the union (if the mode of performing conversion based on the benchmark configuration and then merging is employed, the sub-carrier spatial configuration corresponding to the union set is the benchmark configuration).

For at least two serving cells in a serving cell group which are capable of transmitting the HARQ-ACK of serving cells in this cell group, the sub-carrier spatial configuration of a specific serving cell being used as the benchmark configuration can be negotiated by the UE and the base station through a protocol. If the at least two serving cells are the primary cell 1 and the secondary cell 1, it can be negotiated through a protocol that the sub-carrier spatial configuration of the primary cell is used as the benchmark configuration. The UE can determine the HARQ-ACK codebook according to the converted union set and the benchmark configuration. Optionally, the cell as the benchmark configuration can also be indicated to the UE by the base station.

The method of determining the HARQ-ACK codebook will be further described below by several specific optional embodiments.

An optional embodiment of the disclosure provides a method of determining a Type-1 HARQ-ACK codebook when the HARQ-ACK of PDSCHs of serving cells in a serving cell group can be transmitted in uplink slots of more than one serving cell in the serving cell group and the sub-carrier spatial configurations of PUCCHs for transmitting HARQ-ACK in different serving cells are different (that is, the slot length is different).

The method of determining a Type-1 HARQ-ACK codebook will be described below by taking the HARQ-ACK of PDSCHs of serving cells in a serving cell group being able to be transmitted in uplink slots of two serving cells in the serving cell group as an example. This method can be extended to a situation where the HARQ-ACK of PDSCHs of serving cells in a serving cell group can be transmitted in uplink slots of more than two serving cells in the serving cell group.

It is assumed that the HARQ-ACK of PDSCHs of serving cells in a serving cell group can be transmitted on PUCCHs of two serving cells in the serving cell group, and the serving cells for transmitting PUCCHs are a serving cell 1 and a serving cell 2, respectively. The sub-carrier spatial configuration of the PUCCH in the serving cell 1 for transmitting the PUCCH is μ1. For the serving cell 1 for transmitting the PUCCH, the HARQ-ACK timing relation (dl-DataToUL-ACK) set (also called a set of slot timing values) is K1_1, the elements in the K1_1 are {k11, k12 . . . , k1p}, and the elements in the K1_1 are in unit of slot length using the sub-carrier spatial configuration as μ1. The sub-carrier spatial configuration of the PUCCH in the serving cell 2 for transmitting the PUCCH is μ2. For the serving cell 2 for transmitting the PUCCH, the HARQ-ACK timing relation (dl-DataToUL-ACK) set (also called a set of slot timing values) is K1_2, the elements in the K1_2 are {k21, k22, . . . , k2q}, and the elements in the K1_2 are in unit of slot length using the sub-carrier spatial configuration as μ2. Several optional implementations for the determination of the Type-1 HARQ-ACK codebook will be described below.

### Embodiment 1

One of the set K1_1 and the set K1_2 is used as the set K1 for determining the Type-1 HARQ-ACK codebook. For example, the set K1 for determining the Type-1 HARQ-ACK codebook is a set K1 as K1_1 set configured for the UE by the base station through a high-layer signaling; or, the set K1 for determining the Type-1 HARQ-ACK codebook is a set K1 of the PUCCH for transmitting HARQ-ACK; or, the set K1 for determining the Type-1 HARQ-ACK codebook is the set of the largest sub-carrier spatial configuration in the set K1_1 and the set K1_2; or, the set K1 for determining the Type-1 HARQ-ACK codebook is the set of the smallest sub-carrier spatial configuration in the set K1_1 and the set K1_2; or, the set K1 for determining the Type-1 HARQ-ACK codebook is the set K1 of the primary cell. When the Type-1 HARQ-ACK codebook is determined by using the set K1_1, and when the HARQ-ACK timing relation indication in the DCI for scheduling PDSCHs is an indication using the slot length of the sub-carrier spatial configuration in the set K1_2 as unit, the indicated elements in the K1_2 set should belong to the set K1_1. In this way, the number of HARQ-ACK bits in the Type-1 HARQ-ACK codebook determined by using the set K1_1 will not be changed. Thus, when the elements in the set K1_1 and the set K1_2 are different in time unit, the following method can be employed to determine whether the indicated elements in the set K1_2 belong to the set K1_1.

It is assumed that the sub-carrier spatial configuration of the set K1_1 is μ1, the set K1_1 is {k11, k12, . . . , k1p}, the sub-carrier spatial configuration of the set K1_2 is μ2, and the set K1_2 is {k21, k22, . . . , k2q}. When μ1 is greater than μ2, the indication of the HARC-ACK timing relation in the DCI for scheduling PDSCHs is an indication using the slot length of the sub-carrier spatial configuration in the set K1_2 as unit and the indication value is k2i, and if {k2i*(2^{(μ1-μ2)}), k2i (2^{(μ1-μ2)})+1, . . . , (k2i+1)*(2^{(μ1-μ2)}−1} belongs to the set K1_1, it is considered that the indicated element k2i in the set K1_2 belongs to the set K1-1; or otherwise, it is considered that the indicated element k2i in the set K1_2 does not belong to the set K1-1. For example, it is assumed that the sub-carrier spatial configuration of the set K1_1 is μ1=1, the set K1_1 is {1,2,3,4}, the sub-carrier spatial configuration of the set K1_2 is μ2=0, and the set K1_2 is {0,1,2,3}. When μ1 is greater than μ2, the indication of the HARC-ACK timing relation in the DCI for scheduling PDSCHs is an indication using the slot length (1 ms) of the sub-carrier spatial configuration in the set K1_2 as unit and the indication value is 1, and if {1*(2⁽¹⁻⁰⁾=2, (1+1)*(2⁽¹⁻⁰⁾−1=3} (i.e., {2,3}) belongs to the set K1_1, it is considered that the indicated element 1 in the set K1_2 belongs to the set K1-1. When μ1 is smaller than μ2, the indication of the HARC-ACK timing relation in the DCI for scheduling PDSCHs is an indication using the slot length of the sub-carrier spatial configuration in the set K1_2 as unit and the indication value is k2i, and if down-rounding (k2i*(2^{(μ1-μ2)} belongs to the set K1_1, it is considered that the indicated element in the set K1_2 belongs to the set K1-1; or otherwise, it is considered that the indicated element in the set K1_2 does not belong to the set K1-1. For example, it is assumed that the sub-carrier spatial configuration of the set K1_1 is μ1=0, the set K1_1 is {0, 1,2,3}, the sub-carrier spatial configuration of the set K1_2 is μ2=1, and the set K1_2 is {1,2,3,4}. When μ1 is smaller than μ2, the indication value of the HARQ-ACK timing relation in the DCI for scheduling PDSCHs is 3 and the down-rounding (3*(2⁽⁰⁻¹⁾))=1 belongs to the set K1_1, it is considered that the indicated element 3 in the set K1_2 belongs to the set K1_1. The number of bits of HARQ-ACK transmission can be reduced as far as possible by using this method.

It is to be noted that the conversion of the HARQ-ACK timing relation set may be performed in any one of the conversion modes listed in the optional embodiments (including the following optional embodiments) of the disclosure, or may adopt other conversion modes. The used conversion mode can be negotiated by the base station and the UE through a protocol. The conversion mode may be related to the sub-carrier spatial configurations of different serving cells. For example, the solutions provided in the embodiments of the disclosure are not related to the sub-carrier spatial configuration of the serving cell.

### Embodiment 2

The union set of the set K1_1 and the set K1_2 is used as the set K1 for determining the Type-1 HARQ-ACK codebook. If the sub-carrier spatial configurations of the set K1_1 and the set K1_2 are the same, the union set of the set K1_1 and the set K1_2 is directly used as the set K1 for determining the Type-1 HARQ-ACK codebook. If the sub-carrier spatial configurations of the set K1_1 and the set K1_2 are not the same, the following method may be employed: if the sub-carrier spatial configuration of the set K1_1 is larger than that of the set K1_2, the union set of the converted sets of the set K1_1 and the set K1_2 is used as the set K1 for determining the Type-1 HARQ-ACK codebook. A method of converting the set K1_2 is as follows: if it is assumed that the sub-carrier spatial configuration of the set K1_1 set is μ1, the set K1_1 is {k11, k12, . . . , k1p}, the sub-carrier spatial configuration of the set K1_2 is μ2 and the set K1_2 is {k21, k22, . . . , k2q}, the set K1_2 changed after converting any element k2i in the set K1_2 into {k2i*(2^{(μ1-μ2)}), k2i*(2^{(μ1-μ2)}+1, . . . , (k2i+1)*(2^{(μ1-μ2)})−1, i=1, i=2 . . . , i=q} is K1_2_B, and the union set of the set K1_1 and the converted set K1_2_B of the set K1_2 is used as the set K1 for determining the Type-1 HARQ-ACK codebook. For example, the sub-carrier spatial configuration of the set K1_1 is μ1=1, and the set K1_1 is {1,2,3,4}; the sub-carrier spatial configuration of the set K1_2 is μ2=0, and the set K1_2 is {0,1,2,3}; μ1=1 is larger than μ2=0; the converted set K1_2_B of the set K1_2 is {0,1,2,3,4,5,6,7}; and the union set K1_union sct={0,1,2,3,4,5,6,7} of the set K1_1 {1,2,3,4} and the converted set K1_2_B {0, 1,2,3,4,5,6,7} of the set K1_2 is used as the set K1 for determining the Type-1 HARQ-ACK codebook.

Another method may also be employed: if the sub-carrier spatial configuration of the set K1_1 is larger than that of the set K1_2, the union set of the converted set of the set K1_1 and the set K1_2 is used as the set K1 for determining the Type-1 HARQ-ACK codebook. A method of converting the set K1_1 is as follows: if it is assumed that the sub-carrier spatial configuration of the set K1_1 set is μ1, the set K1_1 is {k11, k12, . . . , k1p}, the sub-carrier spatial configuration of the set K1_2 is μ2 and the set K1_2 is {k21, k22, . . . , k2q}, the set K1_1 changed after converting any element k1i in the set K1_1 into down-rounding (k2i*(2^{(μ2-μ1)})) is K1_1_B, and the union set of the converted set K1_1_B of the set K1_1 and the set K1_2 is used as the set K1 for determining the Type-1 HARQ-ACK codebook. For example, the sub-carrier spatial configuration of the set K1_1 is μ1=1, and the set K1_1 is {1,2,3,4}; the sub-carrier spatial configuration of the set K1_2 is μ2=0, and the set K1_2 is {0,1,2,3}; μ1=1 is larger than μ2-0; the converted set K1_1_B of the set K1_1 is {0,1,2}; and the union set K1_union set={0,1,2,3} of the converted set K1_1_B {0,1,2} of the set K1_1 and the set K1_2 {0,1,2,3} is used as the set K1 for determining the Type-1 HARQ-ACK codebook. By using this method, the number of bits of the HARQ-ACK transmission can be reduced as far as possible without causing any scheduling constraint to the base station.

### Embodiment 3

When the sub-carrier spatial configurations of the set K1_1 and the set K1_2 are not the same, one PUCCH time unit (e.g., slot/sub-slot) in the serving cell 1 for transmitting the PUCCH may be overlapped with one or more PUCCH time units in the serving cell 2 in time domain, and one PUCCH resource in the serving cell 1 for transmitting the PUCCH may be overlapped with one or more PUCCH resources in the serving cell 2 in time domain. For example, the PUCCH resources may be PUCCH sources carrying the HARQ-ACK. The mapping relationship between PUCCH time units (or PUCCH resources in each serving cell for transmitting the PUCCH may be determined by the predefined rule A. For example, one PUCCH time unit in the serving cell 1 for transmitting the PUCCH may be associated with one or more PUCCH time units in the serving cell 2.

The UE can generate HARQ-ACK sub-codebooks for one or more PUCCH time units in each uplink carrier, respectively; and, the UE can also HARQ-ACK sub-codebooks for one or more PUCCH resources in each uplink carrier, respectively. For example, the UE generates HARQ-ACK sub-codebooks for the associated PUCCH time units (or PUCCH resources), respectively. For example, HARQ-ACK sub-codebooks of one or more PUCCH time units (or PUCCH resources) in each serving cell for transmitting the PUCCH are obtained by using the set K1_1 and the set K1_2, respectively, and the HARQ-ACK sub-codebooks are cascaded according to the predefined rule B to obtain an HARQ-ACK codebook. For example, the HARQ-ACK sub-codebook 1 is obtained according to the set K1_1, the HARQ-ACK sub-codebook 2 is obtained according to the set K1_2, and the HARQ-ACK sub-codebook 1 and the HARQ-ACK sub-codebook 2 are cascaded to obtain an HARQ-ACK codebook. For example, the number of bits of the HARQ-ACK sub-codebook 1 is L1 according to the set K1_1, the number of bits of the HARQ-ACK sub-codebook 2 is L2 according to the set K1_2, and the number of bits of the HARQ-ACK codebook obtained by cascading the HARQ-ACK sub-codebook 1 and the HARQ-ACK sub-codebook 2 is L1+L2. When the sub-carrier spatial configurations of the set K1_1 and the set K1_2 are the same, the above method can also be employed.

It is to be noted that the HARQ-ACK codebook/sub-codebook in the embodiments of the present disclosure may also be an HARQ-ACK codebook/sub-codebook containing only HARQ-ACK information of an SPS PDSCH. For example, the HARQ-ACK codebook/sub-codebook containing only HARQ-ACK information of an SPS PDSCH may be generated by the method for generating an HARQ-ACK codebook/sub-codebook containing only HARQ-ACK information of an SPS PDSCH according to the 3GPP TS 38.213. In this way, no scheduling constraint to the base station can be caused.

For example, the HARQ-ACK of the SPS PDSCH is configured for transmission in PUCCH-1 in the serving cell 1, the HARQ-ACK of the PDSCH scheduled by the DCI is indicated for transmission in PUCCH-2 in the serving cell 1, and the PUCCH-1 and the PUCCH-2 are overlapped in time domain. In one optional solution, the HARQ-ACK sub-codebook 1 is generated according to the set K1 configured for the serving cell 2, the HARQ-ACK sub-codebook 2 is generated according to the SPS PDSCH transmitted in the serving cell 1, and the HARQ-ACK sub-codebook 1 and the HARQ-ACK sub-codebook 2 are cascaded to obtain a codebook for transmission in the PUCCH of the serving cell 2.

It is to be noted that, in the embodiments of the present disclosure, if the UE is configured with a Type-1 HARQ-ACK codebook and if one HARQ-ACK codebook contains a plurality of HARQ-ACK sub-codebooks, and it can be stipulated through a protocol and/or configured through a high-layer signaling that the HARQ-ACK information of one PDSCH may be contained in one or more HARQ-ACK sub-codebooks. The number of bits of HARQ-ACK transmission can be reduced as far as possible by using this method.

### Embodiment 4

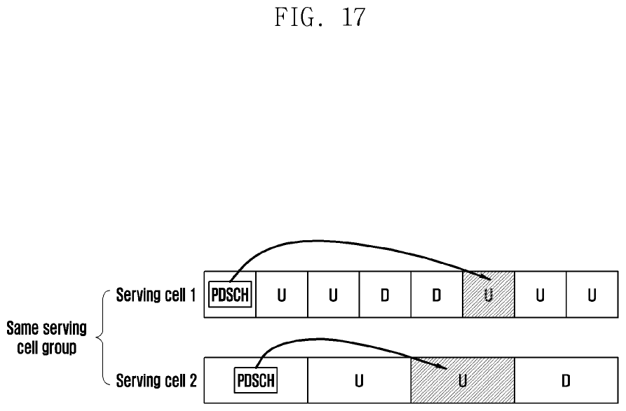

One of the set K1_1 and the set K1_2 is used as the set K1 for determining the Type-1 HARQ-ACK codebook. For example, the set K1 for determining the Type-1 HARQ-ACK codebook is a set K1 as K1_1 set configured for the UE by the base station through a high-layer signaling; or, the set K1 for determining the Type-1 HARQ-ACK codebook is a set K1 of the PUCCH for transmitting HARQ-ACK; or, the set K1 for determining the Type-1 HARQ-ACK codebook is the set of the largest sub-carrier spatial configuration in the set K1_1 and the set K1_2; or, the set K1 for determining the Type-1 HARQ-ACK codebook is the set of the smallest sub-carrier spatial configuration in the set K1_1 and the set K1_2; or, the set K1 for determining the Type-1 HARQ-ACK codebook is the set K1 of the primary cell. When the Type-1 HARQ-ACK codebook is determined by using the set K1_1, the elements in the set K1_2 that can be used to schedule the HARQ-ACK timing relation indication in the DCI for scheduling PDSCHs need to satisfy a certain condition, and the elements not satisfying this condition in the set K1_2 cannot be used to schedule the HARQ-ACK timing relation indication in the DCI for scheduling PDSCHs. This condition is that the PUCCH resources indicated by the elements in the set K1_2 in the DCI for scheduling PDSCHs are overlapped in time with the PUCCH resource indicated by at least one element in the set K1_1 in the DCI for scheduling PDSCHs (this condition may also be that the slots where the PUCCH resources indicated by the elements in the set K1_2 in the DCI for scheduling PDSCHs are located are overlapped in time with the slot where the PUCCH resource indicated by at least one element in the set K1_1 in the DCI for scheduling PDSCHs is located; the following description is given by taking the PUCCH resources indicated by the elements in the set K1_2 in the DCI for scheduling PDSCHs being overlapped in time with the PUCCH resources indicated by the elements in the set K1_1 in the DCI for scheduling PDSCHs as an example, but it is also applied to a situation where the slots where the PUCCH resources indicated by the elements in the set K1_2 in the DCI for scheduling PDSCHs are located are overlapped in time with the slots where the PUCCH resources indicated by the elements in the set K1_1 in the DCI for scheduling PDSCHs are located). If the PDSCHs scheduled by DCI of PUCCH resources indicated by the elements in the set K1_2 are overlapped in time with the PDSCH scheduled by the DCI of the PUCCH resource indicated by at least one element in the set K1_1, it is considered that the elements in the K1_2 satisfy this condition. FIG. 17 is a schematic diagram of determining PUCCH resources according to an example of the disclosure. As shown in FIG. 17, the PUCCH resource indicated by the element {2} in the set K1_2 is overlapped in time with the PUCCH resource indicated by the element {5} in the set K1_1, and the PDSCH scheduled by the DCI of the PUCCH resources indicated by the element {2} in the set K1_2 is overlapped in time with the PDSCH scheduled by the DCI of the PUCCH resource indicated by the element {5} in the set K1_1, so it is considered that element {2} in the set K1_2 satisfies this condition. The number of HARQ-ACK bits can be reduced as far as possible by using this method.

Or, in another optional solution, when the UE receives the PDSCH scheduled by the DCI of the PUCCH resource indicated by the element in the set K1_2 satisfying the above condition, the HARQ-ACK of the PDSCH is transmitted; and, when the UE receives the PDSCH scheduled by the DCI of the PUCCH resource indicated by the element in the set K1_2 not satisfying the above condition, the HARQ-ACK of the PDSCH is discarded and not transmitted. The number of HARQ-ACK bits can be reduced as far as possible by using this method.

Or, in another optional solution, all elements in the set K1-2 configured by the UE satisfy the above condition. The number of HARQ-ACK bits can be reduced as far as possible by using this method.

Or, in another optional solution, when the sub-carrier spatial configurations of the set K1_1 and the set K1_2 are not the same, the HARQ-ACK sub-codebook 1 is obtained according to the set K1_1, the HARQ-ACK sub-codebook 1 is obtained according to the set K1_2_R consisting of the elements in the set K_2 not satisfying the condition, and the HARQ-ACK sub-codebook 1 and the HARQ-ACK sub-codebook 2 are cascaded to obtain an HARQ-ACK codebook. For example, the number of bits of the HARQ-ACK sub-codebook 1 is L1 according to the set K1_1, the number of bits of the HARQ-ACK sub-codebook 2 is L2 according to the set K1_2_R consisting of the elements in the set K1_2 not satisfying the condition, and the number of bits of the HARQ-ACK codebook obtained by cascading the HARQ-ACK sub-codebook 1 and the HARQ-ACK sub-codebook 2 is L1+L2. By using this method, the number of HARQ-ACK bits can be reduced as far as possible without causing any scheduling constraint to the base station.

### Embodiment 5

When the base station configures a Type-2 HARQ-ACK codebook for the UE, that is, when pdsch-HARQ-ACK-Codebook=dynamic, the method of determining the HARQ-ACK codebook will be described below. When the sub-carrier spatial configurations of the set K1_1 and the set K1_2 are not the same, one PUCCH time unit (e.g., slot/sub-slot) in the serving cell 1 for transmitting the PUCCH may be overlapped with one or more PUCCH time units in the serving cell 2 in time domain, and one PUCCH resource in the serving cell 1 for transmitting the PUCCH may be overlapped with one or more PUCCH resources in the serving cell 2 in time domain. At this time, the count downlink assignment index (DAI) and sum DAI in the DCI of the PDSCH-to-PUCCH timing relation by the elements in the set K1_1 are jointly counted with the count DAI and sum DAI in the DCI of the PDSCH-to-PUCCH timing relation indicated by the elements in the set K1_2. The advantage of this method is that the misunderstanding of the number of HARQ-ACK bits by the base station and the UE can be reduced. For example, the DCI in the slot 1 indicates the PDSCH-to-PUCCH timing relation by using the elements in the set K1_1, and the count DAI and sum DAI in the DCI are equal to 1; and, the DCI in the slot 2 indicates the PDSCH-to-PUCCH timing relation by using the elements in the set K1_2, and the count DAI and sum DAI in the DCI are equal to 2.

Or, the count DAI and sum DAI in the DCI of the PDSCH-to-PUCCH timing relation by the elements in the set K1_1 are separately counted with the count DAI and sum DAI in the DCI of the PDSCH-to-PUCCH timing relation indicated by the elements in the set K1_2. The advantage of this method is that the implementation can be simple. For example, the DCI in the slot 1 indicates the PDSCH-to-PUCCH timing relation by using the elements in the set K1_1, and the count DAI and sum DAI in the DCI are equal to 1; and, the DCI in the slot 2 indicates the PDSCH-to-PUCCH timing relation by using the elements in the set K1_2, and the count DAI and sum DAI in the DCI are equal to 1.

A method of determining a Type-1 HARQ-ACK codebook is provided, when the HARQ-ACK of PDSCHs of serving cells in a serving cell group can be transmitted in uplink slots of more than one serving cell in the serving cell group and the sub-carrier spatial configurations of PUCCHs for transmitting HARQ-ACK in different serving cells are the same (that is, the slot length is different). The method of determining a Type-1 HARQ-ACK codebook will be described below by taking the HARQ-ACK of PDSCHs of serving cells in a serving cell group being able to be transmitted in uplink slots of two serving cells in the serving cell group as an example. This method can be extended to a situation where the HARQ-ACK of PDSCHs of serving cells in a serving cell group can be transmitted in uplink slots of more than two serving cells in the serving cell group.

It is assumed that the HARQ-ACK of PDSCHs of serving cells in a serving cell group can be transmitted on PUCCHs of two serving cells in the serving cell group, and the serving cells for transmitting PUCCHs are a serving cell 1 and a serving cell 2, respectively. The sub-carrier spatial configuration of the PUCCH in the serving cell 1 for transmitting the PUCCH is μ1. For the serving cell 1 for transmitting the PUCCH, the HARQ-ACK timing relation (dl-DataToUL-ACK) set (also called a set of slot timing values) is K1_1, the elements in the K1_1 are {k11, k12, . . . , k1p}, and the elements in the K1_1 are in unit of slot length using the sub-carrier spatial configuration as μ1. The sub-carrier spatial configuration of the PUCCH in the serving cell 2 for transmitting the PUCCH is μ1. For the serving cell 2 for transmitting the PUCCH, the HARQ-ACK timing relation (dl-DataToUL-ACK) set (also called a set of slot timing values) is K1_2, the elements in the K1_2 are {k21, k22, . . . , k2q}, and the elements in the K1_2 are in unit of slot length using the sub-carrier spatial configuration as μ1. Several optional implementations for the determination of the Type-1 HARQ-ACK codebook will be described below.

### Embodiment 1

One of the set K1_1 and the set K1_2 is used as the set K1 for determining the Type-1 HARQ-ACK codebook. For example, the set K1 for determining the Type-1 HARQ-ACK codebook is a K1 set as the set K1_1 configured for the UE by the base station through a high-layer signaling; or, the set K1 for determining the Type-1 HARQ-ACK codebook is a set K1 of the PUCCH for transmitting HARQ-ACK; or, the set K1 for determining the Type-1 HARQ-ACK codebook is the set K1 of the primary cell. When the Type-1 HARQ-ACK codebook is determined by using the set K1_1, the indicated element in the set K1_2 should belong to the set K1_1. In this way, the number of HARQ-ACK bit in the Type-1 HARQ-ACK codebook determined by using the set K1_1 will not be changed.

### Embodiment 2

The union set of the set K1_1 and the set K1_2 is used as the set K1 for determining the Type-1 HARQ-ACK codebook. The union set of the set K1_1 and the set K1_2 is directly used as the set K1 for determining the Type-1 HARQ-ACK codebook.

### Embodiment 3

The HARQ-ACK timing relation (dl-DataToUL-ACK) set (also called a set of slot timing values) for transmitting the PUCCH in the serving cell 1 configured for the UE by the base station through a high-layer signaling is K1_1, and the HARQ-ACK timing relation (dl-DataToUL-ACK) set (also called a set of slot timing values) for transmitting the PUCCH in the serving cell 2 by the UE is also K1_1. That is, the HARQ-ACK timing relation (dl-DataToUL-ACK) set (also called a set of slot timing values) for transmitting the PUCCH in the serving cell 1 by the UE and the HARQ-ACK timing relation (dl-DataToUL-ACK) set (also called a set of slot timing values) for transmitting the PUCCH in the serving cell 2 by the UE are the same. Optionally, in this optional embodiment, the base station can configure, for the UE, an HARQ-ACK timing relation (dl-DataToUL-ACK) set for transmitting the PUCCH through a high-layer signaling. This set is the HARQ-ACK timing relation (dl-DataToUL-ACK) set for transmitting the PUCCH in the serving cell 1 by the UE and also the HARQ-ACK timing relation for transmitting the PUCCH in the serving cell 1 by the UE.

In one optional solution, when the sub-carrier spatial configurations of the serving cell 1 and the serving cell 2 are the same or different, the UE can employ different methods of determining the K1 set for the Type-1 HARQ-ACK codebook according to the protocol or the received high-layer signaling configuration.

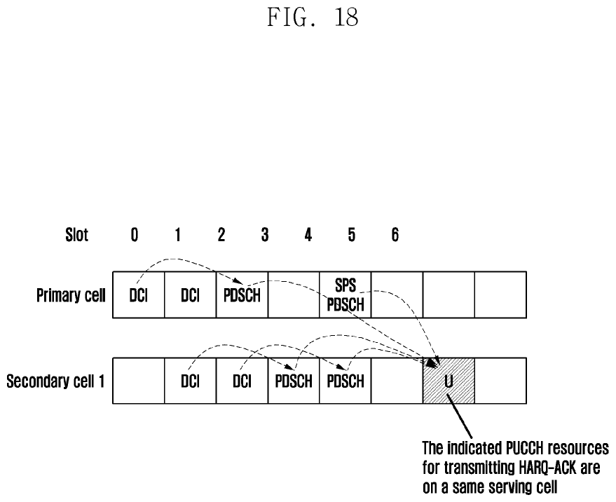

In one optional solution, for the UE, when the HARQ-ACK of PDSCHs of serving cells in a serving cell group configured for the UE can be transmitted on PUCCHs in two serving cells in this serving cell group and the serving cells for transmitting PUCCHs is the serving cell 1 and the serving cell 2, respectively, more than one PUCCH resource of different serving cells obtained by the UE through the received information indication are not overlapped in time. That is, more than one PUCCH resource overlapped in time obtained by the UE through the received information indication are in only one serving cell. FIG. 18 is a schematic diagram of determining PUCCH resources according to another example of the disclosure. As shown in FIG. 18, for example, the PUCCH resource for the HARQ-ACK of the SPS PDSCH of the primary cell in the slot 1 is in the secondary cell 1 in the slot 6, and the PUCCH resources for the HARQ-ACK of the PDSCH scheduled by the DCI of the primary cell in the slot 2 and the PDSCH scheduled by the DCI of the secondary cell 1 in the slots 3,4 are in the secondary cell 1 in the slot 6. The advantage of this method is that it is easy for the UE to determine the HARQ-ACK codebook and it is convenient for power control.

In another optional solution, when the sub-carrier spatial configurations of the serving cell 1 and the serving cell 2 are not the same, more than one PUCCH resource of different serving cells obtained by the UE through the received information indication cannot be overlapped in time. When the sub-carrier spatial configurations of the serving cell 1 and the serving cell 2 are the same, more than one PUCCH resource of different serving cells obtained by the UE through the received information indication can be overlapped in time.

In another solution, when the sub-carrier spatial configurations of the serving cell 1 and the serving cell 2 are not the same, the UE determine the Type-1 HARQ-ACK codebook according to the sub-carrier spatial configuration of the serving cell 1 and the K1 set K1_1 of the serving cell 1, the sub-carrier spatial configuration of the serving cell 2 and the K1 set K1_2 of the serving cell 2 as well as the sub-carrier spatial configurations of all downlink serving cells for scheduling PDSCHs and the uplink/downlink slots of the downlink serving cells.

At this time, a union set can be determined according to the sub-carrier spatial configuration of the serving cell 1 and the K1 set K1_1 of the serving cell 1, the sub-carrier spatial configuration of the serving cell 2 and the K1 set K1_2 of the serving cell 2 as well as the sub-carrier spatial configurations of all downlink serving cells for scheduling PDSCHs and the uplink/downlink slots of the downlink serving cells, so that the Type-1 HARQ-ACK codebook is determined. It is also possible that, the Type-1 HARQ-ACK codebook is determined according to the sub-carrier spatial configuration of the serving cell 1 and the K1 set K1_1 of the serving cell 1, and it is determined, according to the sub-carrier spatial configuration of the serving cell 1 and the K1 set K1_1 of the serving cell 1, the sub-carrier spatial configuration of the serving cell 2 and the K1 set K1_2 of the serving cell 2 as well as the sub-carrier spatial configurations of all downlink serving cells for scheduling PDSCHs and the uplink/downlink slots of the downlink serving cells, that which elements in the K1_2 can be used for the indicated PUCCH resources without changing the Type-1 HARQ-ACK codebook determined according to the sub-carrier spatial configuration of the serving cell 1 and the K1 set K1_1 of the serving cell 1.

The another optional solution is a solution described by taking the sub-carrier spatial configurations of the serving cell 1 and the serving cell 2 being not the same and the sub-carrier spatial configurations of the serving cell 1 and the serving cell 2 being the same as an example, and it is also application to situations where the sub-carrier spatial configurations of the serving cell 1 and the serving cell 2 are the same and the sub-carrier spatial configurations of the serving cell 1 and the serving cell 2 are not the same. In addition, the UE can also determine according to the protocol or the received high-layer signaling configuration that any one of the above embodiments is employed in the situations where the sub-carrier spatial configurations of the serving cell 1 and the serving cell 2 are the same and the sub-carrier spatial configurations of the serving cell 1 and the serving cell 2 are not the same.

The method shown in FIG. 5 is described by taking a user equipment as the execution body, and the method provided in the embodiments of the disclosure will be described below by taking a base station as the execution body. It should be understood that the essential contents of the methods are the same no matter whether the description is given from the perspective of the base station or the user equipment, and the methods executed by the base station and the user equipment are corresponding to each other. The steps that can be executed by the base station can refer to the above detailed description. A communication method executed by a base station in a wireless communication system according to an embodiment of the disclosure may comprise steps of:
transmitting configuration information to a UE, the configuration information being used for configuring at least two serving cells for transmitting UCI; and
transmitting, to the UE, DCI used for scheduling PDSCHs, wherein, when PUCCH resources indicated by at least two DCIs are PUCCH resources of at least two serving cells overlapped in time domain, the PUCCH resources indicated by a specified DCI in the at least two DCIs are determined as PUCCH resources for transmitting UCI of PDSCHs scheduled by the at least two DCIs.

Optionally, the method may further comprise:
transmitting group common DCI to the UE, the group common DCI containing indication information used for determining a serving cell to which a TPC command in the group common DCI is applied. The description of the group common DCI can refer to the above contents, and will not be repeated here.

Based on the same principle as the methods according to the embodiments of the disclosure, an embodiment of the disclosure further provides another communication apparatus. The communication apparatus may comprise a transceiver module and a transmission resource determination module, wherein:
the transceiver module is configured to receive configuration information used for configuring at least two serving cells for transmitting UCI, and configured to receive DCI used for scheduling PDSCHs; and the transmission resource determination module is configured to determine,
according to the DCI, PUCCH resources for transmitting UCI of the PDSCH, wherein, when the PUCCH resources indicated by at least two DCIs are PUCCH resources of at least two serving cells overlapped in time domain, the PUCCH resources indicated by a specified DCI in the at least two DCIs are determined as PUCCH resources for transmitting UCI of PDSCHs scheduled by the at least two DCIs.

The apparatus may be implemented as a user equipment.

Optionally, the UCI comprises at least one of HARQ-ACK information, CSI and scheduling request (SR) information.

Optionally, the specified DCI in the at least two DCIs is any one of the following:
the last received DCI in the at least two DCIs;
the last received DCI comprising first indication information in the at least two DCIs;
the first received DCI in the at least two DCIs;
the first received DCI comprising first indication information in the at least two DCIs;
wherein the first indication information is used to indicate serving cells where PUCCH resources are located.

Optionally, the apparatus further comprises a transmission power control module; and, if the specified DCI is a first type of DCI, the first type of DCI is DCI not containing the first indication information for indicating serving cells where PUCCH resources for transmitting UCI are located, or the first type of DCI is DCI containing the first indication information.

Optionally, the transmission power control module may be configured to executed at least one of the following:
controlling, according to a transmission power control (TPC) command included in the first type of DCI, the power of a PUCCH for transmitting the UCI of the PDSCH scheduled by the DCI;
not applying a TPC command included in a non-first type of DCI to the power control of a PUCCH for transmitting the UCI of the PDSCH scheduled by the DCI, or applying a TPC command included in a non-first type of DCI to the power control of a PUCCH in a later time of the serving cell where the PUCCH resource for transmitting the UCI indicated by the DCI is located, the later time being a time unit later than the time unit where the PUCCH resource indicated by the DCI is located; and
for a non-first type of DCI, if there is a first type of DCI received before receiving the DCI in the at least two DCIs, controlling the power of a PUCCH for transmitting the UCI of the PDSCH scheduled by the DCI according to the TPC command included in the DCI; and if there is no first type of DCI received before the DCI in the at least two DCIs, not applying the TPC command included in the DCI to the power control of a PUCCH for transmitting the UCI of the PDSCH scheduled by the DCI or being used for power control of a PUCCH in a later time of the serving cell where a PUCCH resource for transmitting the UCO corresponding to the DCI is located.

Optionally, the apparatus further comprises a transmission power control module; the transceiver module is further configured to receive group common DCI, the group common DCI containing second indication information for indicating a serving cell to which a TPC command in the group common DCI is applied; and, the transmission power control module is further configured to:
determine, according to the second indication information, the serving cell to which the TPC command in the group common DCI is applied; and
for the received DCI for scheduling a PDSCH, if the serving cell where the PUCCH resource for transmitting the UCI of the PDSCH scheduled by the DCI is located is the serving cell indicated by the second indication information, apply the TPC command included in the group common DCI to the power control of the PUCCH for transmitting the UCI of the PDSCH scheduled by the DCI.

Optionally, the group common DCI further comprises third indication information for indicating a power control adjustment state of the PUCCH for transmitting the UCI in the serving cell indicated by the second indication information; and, if the serving cell where the PUCCH resource for transmitting the UCI of the PDSCH scheduled by the DCI is located is the serving cell indicated by the second indication information, the transmission power control module is further configured to:

determine, according to the power control adjustment state indicated by the third indication information, the transmission power of the PUCCH for transmitting the UCI of the PDSCH scheduled by the DCI.

Optionally, the second indication information is used to jointly indicate the serving cell to which the TPC command in the group DCI is applied and the power control adjustment state of the PUCCH for transmitting the UCI in the serving cell; and, if the serving cell where the PUCCH resource for transmitting the UCI of the PDSCH scheduled by the DCI is located is the serving cell indicated by the second indication information, the transmission power control module is further configured to:

determine, according to the power control adjustment state indicated by the second indication information, the transmission power of the PUCCH for transmitting the UCI of the PDSCH scheduled by the DCI.

Optionally, the number of bits of the third indication information is determined according to a first numerical value; the first numerical value is the largest value among a plurality of second numerical values; and the plurality of second numerical values is the number of power control adjustment states of each serving cell in at least one serving cell, in the serving cell group of the UE, which is capable of transmitting the UCI of the serving cell group.

Optionally, the number of bits of the second indication information is determined according to a third numerical value; the third numerical value is the sum of a plurality of second numerical values; and the plurality of second numerical values is the number of power control adjustment states of each serving cell in at least one serving cell, in the serving cell group of the UE, which is capable of transmitting the UCI of the serving cell group.

Optionally, the UCI comprises HARQ-ACK information; for the DCI belonging to a same serving cell group in the received DCI for scheduling PDSCHs, a static HARQ-ACK codebook used by the HARQ-ACK information of the PDSCH scheduled by this DCI is determined according to an HARQ-ACK timing relation set of a specified serving cell in at least two serving cells capable of transmitting the HARQ-ACK information in the serving cell group, or according to a union set of HARQ-ACK timing relation sets of serving cells in at least two serving cells capable of transmitting the HARQ-ACK information; or, when sub-carrier spatial configurations of at least two serving cells capable of transmitting the HARQ-ACK information in the serving cell group are the same, the HARQ-ACK timing relation sets of the at least two serving cells are a same set.

Optionally, the specified serving cell is any one of the following:
a serving cell having the largest sub-carrier spatial configuration in the serving cell group;
a serving cell having the smallest sub-carrier spatial configuration in the serving cell group;
a serving cell where the PUCCH resource indicated by the specified DCI is located;
and a primary cell of the UE.

Optionally, the transmission resource determination module is further configured to:
for DCI of a serving cell in a serving cell group, if the serving cell where the PUCCH resource for transmitting the HARQ-ACK information of the PDSCH scheduled by the DCI is not the specified serving cell and a first sub-carrier spatial configuration of the serving cell for transmitting the HARQ-ACK information is different from a second sub-carrier spatial configuration of the specified serving cell, convert a first indication value in the specified DCI into a second indication value according to the first sub-carrier spatial configuration and the second sub-carrier spatial configuration;
wherein the second indication value is a value in the HARQ-ACK timing relation set of the specified serving cell.

Optionally, if there are at least two sub-carrier spatial configurations among the sub-carrier spatial configurations of serving cells in the at least two serving cells capable of transmitting HARQ-ACK, by using one of the at least two sub-carrier spatial configurations as a reference configuration, the union set is a union set of HARQ-ACK timing relation sets obtained after converting the HARQ-ACK timing relation sets corresponding to other sub-carrier spatial configurations according to the other sub-carrier spatial configurations and the reference configuration and an HARA-ACK timing relation set corresponding to the reference configuration.

Optionally, the transceiver module is further configured to: for each received DCI for scheduling PDSCHs, transmit the corresponding UCI according to the determined PUCCH resource for transmitting the UCI of the PDSCH scheduled by the DCI.

An embodiment of the disclosure further provides a communication apparatus,
wherein the apparatus may be implemented as a base station, and the apparatus may comprise a transceiver module configured to:
transmit configuration information to a UE, the configuration information being used for configuring at least two serving cells for transmitting UCI; and
transmit, to the UE, DCI used for scheduling PDSCHs, wherein, when PUCCH resources indicated by at least two DCIs are PUCCH resources of at least two serving cells overlapped in time domain, the PUCCH resources indicated by a specified DCI in the at least two DCIs are determined as PUCCH resources for transmitting UCI of PDSCHs scheduled by the at least two DCIs.

Optionally, the transceiver module is further configured to: transmit group common DCI to the UE. The group common DCI comprises indication information for indicating a serving cell to which a TPC command in the group common DCI is applied.

Optionally, the transceiver module is further configured to receive UCI transmitted by the UE.

Based on the same principle as the methods according to the embodiments of the disclosure, an embodiment of the disclosure provides an electronic device, comprising: a memory and a storage; and, at least one program, which is stored in the memory and can implement the method according to any one of the optional embodiments of the disclosure when executed by the processor. Optionally, the electronic device may be implemented as a user equipment, and the device contains at least one processor configured to execute the method executed by a user equipment according to any one of the optional embodiments of the disclosure. Optionally, the electronic device may be implemented as a base station, and the device contains at least one processor configured to execute the method executed by a base station according to any one of the optional embodiments of the disclosure.

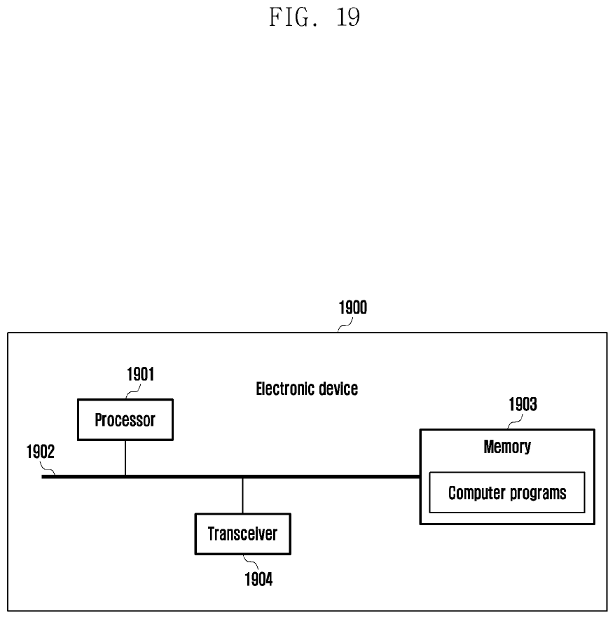

FIG. 19 shows a schematic structure diagram of an electronic device according to an embodiment of the disclosure. As shown in FIG. 19, the electronic apparatus 1900 shown in FIG. 19 comprises a processor 1901 and a memory 1903. The processor 1901 is connected to the memory 1903, for example, via a bus 1902. Optionally, the electronic device 1900 may further comprise a transceiver 1904. The transceiver 1904 may be configured for data interaction between the electronic device and other electronic devices, for example, transmitting data and/or receiving data, etc. It is to be noted that, in practical applications, the number of the transceiver 1904 is not limited to 1, and the structure of the electronic device 1900 does not constitute any limitation to the embodiments of the disclosure.

The processor 1901 may be a central processing unit (CPU), a general-purpose processor, a digital signal processor (DSP), an application specific integrated circuit (ASIC), a field programmable gate array (FPGA) or other programmable logic devices, a transistor logic device, a hardware component or any combination thereof. The processor can implement or execute various exemplary logic blocks, modules and circuits described in the disclosure. The processor 1901 may also be a combination for realizing computing functions, for example, a combination of one or more microprocessors, a combination of DSPs and microprocessors, etc.

The bus 1902 may comprise a passageway for transferring information between the above components. The bus 1902 may be a peripheral component interconnect (PCI) bus, an extended industry standard architecture (EISA) bus, etc. The bus 1902 may be classified into address bus, data bus, control bus, etc. For case of representation, the bus is represented by only one bold line in FIG. 19, but it does not mean that there is only one bus or one type of buses.

The memory 1903 may be, but not limited to, a read only memory (ROM) or other types of static storage devices capable of storing static information and instructions, a random access memory (RAM) or other types of dynamic storage devices capable of storing information and instructions, or an electrically erasable programmable read only memory (EEPROM), compact disc read only memory (CD-ROM) or other optical disk storages, optical disc storages (including compact disc, laser disc, optical disc, digital versatile optical disc, Blu-ray disc, etc.), magnetic disk storage mediums or other magnetic storage devices, or any other media that can be used to carry or store desired program codes in form of instructions or data structures and can be accessed by a computer.

The memory 1903 is configured to store application codes (computer programs) for executing the solutions in the disclosure and is controlled and executed by the processor. The processor 1901 is configured to execute the application codes stored in the memory 1903 to implement the contents in the above method embodiments.

It should be understood that, although the steps in the flowcharts in the accompanying drawings are shown sequentially as indicated by arrows, these steps are not necessarily executed sequentially in the order indicated by the arrows. Unless otherwise clearly stated, the execution of these steps is not limited to a strict order and these steps may be executed in other orders. Moreover, at least some of the steps in the flowcharts of the accompanying drawings may comprise a plurality of sub-steps or a plurality of sub-stages. These sub-steps or sub-stages may be executed at different moments rather than at a same moment. These sub-steps or sub-stages are not necessarily executed sequentially, and instead, they may be executed in turn or alternately with other steps or with at least some of sub-steps or sub-stages of other steps.

The foregoing description merely shows some implementations of the present invention. It should be pointed out that, to a person of ordinary skill in the art, various improvements and modifications can be made without departing from the principle of the present invention, and these improvements and modifications shall be regarded as falling into the protection scope of the present invention.

1-15. (canceled)

16. A method performed by a user equipment (UE) in a wireless communication system, the method comprising:
receiving configuration information;
identifying, based on the configuration information, at least two serving cells for transmitting uplink control information (UCI) in different serving cells;
receiving downlink control information (DCI) scheduling a physical downlink shared channel (PDSCH);
determining semi-static hybrid automatic repeat request-acknowledgement (HARQ-ACK) codebook for PDSCHs based on a set of slot timing values; and
transmitting the UCI including the semi-static HARQ-ACK codebook, based on a physical uplink control channel (PUCCH) resource,
wherein the set of slot timing values is associated with a primary cell or with a specific cell, indicated by the DCI, in which the PUCCH resource is located.

17. The method according to claim 16, further comprising:
receiving second DCI scheduling a PDSCH; and
determining the PUCCH resource based on one of the DCI and the second DCI.

18. The method according to claim 16, wherein the one of the DCI and the second DCI is one of:
a last received DCI among the DCI and the second DCI,
the last received DCI containing information for indicating the specific cell associated with the PUCCH resource among the at least two serving cells, among the DCI and the second DCI,
a first received DCI among the DCI and the second DCI, or
the first received DCI containing the information among the DCI and the second DCI.

19. The method according to claim 16, wherein, in case that the DCI includes information for indicating the specific cell associated with the PUCCH resource among the at least two serving cells, the set of slot timing values is associated with the specific cell.

20. The method according to claim 16, further comprising:
receiving group common DCI, the group common DCI containing first indication information for indicating a serving cell to which a transmit power control (TPC) command in the group common DCI is applied;
determining, based on the first indication information, the serving cell to which the TPC command in the group common DCI is applied; and
in case that the specific cell where the PUCCH resource is located is the serving cell indicated by the first indication information, applying the TPC command included in the group common DCI to a power control of a PUCCH for transmitting the UCI.

21. The method according to claim 20, wherein the group common DCI further comprises second indication information for indicating a power control adjustment state of a PUCCH for transmitting the UCI in the serving cell indicated by the first indication information, and in case that the specific cell where the PUCCH resource is located is the serving cell indicated by the first indication information, the method further comprises:
determining, based on the power control adjustment state indicated by the second indication information, the transmission power of the PUCCH for transmitting the UCI.

22. A method performed by a base station in a wireless communication system, the method comprising:
transmitting, to a user equipment (UE), configuration information for configuring at least two serving cells associated with uplink control information (UCI) to be transmitted in different serving cells;
transmitting, to the UE, downlink control information (DCI) scheduling a physical downlink shared channel (PDSCH); and
receiving, from the UE, the UCI including semi-static hybrid automatic repeat request-acknowledgement (HARQ-ACK) codebook for PDSCHs, based on a physical uplink control channel (PUCCH) resource,
wherein the semi-static HARQ-ACK codebook for PDSCHs is based on a set of slot timing values, and
wherein the set of slot timing values is associated with a primary cell or with a specific cell, indicated by the DCI, in which the PUCCH resource is located.

23. The method according to claim 22, further comprising:
transmitting, to the UE, second DCI scheduling a PDSCH,
wherein the PUCCH resource is determined based on one of the DCI and the second DCI.

24. The method according to claim 23, wherein the one of the DCI and the second DCI is one of:
a last received DCI among the DCI and the second DCI,
the last received DCI containing information for indicating the specific cell associated with the PUCCH resource among the at least two serving cells, among the DCI and the second DCI,
a first received DCI among the DCI and the second DCI, or
the first received DCI containing the information among the DCI and the second DCI.

25. The method according to claim 23, further comprising:
transmitting, to the UE, group common DCI, the group common DCI including first indication information for indicating a serving cell to which a transmit power control (TPC) command in the group common DCI is applied.

26. The method according to claim 23,
wherein, in case that the DCI includes information for indicating the specific cell associated with the PUCCH resource among the at least two serving cells, the set of slot timing values is associated with the specific cell.

27. A user equipment (UE) in a wireless communication system, the UE comprising:
a transceiver; and
a controller configured to:
receive, via the transceiver, configuration information,
identify, based on the configuration information, at least two serving cells for transmitting uplink control information (UCI) in different serving cells,
receive, via the transceiver, downlink control information (DCI) scheduling a physical downlink shared channel (PDSCH);
determine semi-static hybrid automatic repeat request-acknowledgement (HARQ-ACK) codebook for PDSCHs based on a set of slot timing values, and
transmit, via the transceiver, the UCI including the semi-static HARQ-ACK codebook, based on a physical uplink control channel (PUCCH) resource,
wherein the set of slot timing values is associated with a primary cell or with a specific cell, indicated by the DCI, in which the PUCCH resource is located.

28. The UE according to claim 27,
wherein, in case that the DCI includes information for indicating the specific cell associated with the PUCCH resource among the at least two serving cells, the set of slot timing values is associated with the specific cell.

29. A base station in a wireless communication system, the base station comprising:
a transceiver; and
a controller configured to:
transmit, via the transceiver to a user equipment (UE), configuration information for configuring at least two serving cells associated with uplink control information (UCI) to be transmitted in different serving cells,
transmit, via the transceiver to the UE, downlink control information (DCI) scheduling a physical downlink shared channel (PDSCH), and
receive, via the transceiver from the UE, the UCI including semi-static hybrid automatic repeat request-acknowledgement (HARQ-ACK) codebook for PDSCHs, based on a physical uplink control channel (PUCCH) resource,
wherein the semi-static HARQ-ACK codebook for PDSCHs is based on a set of slot timing values, and
wherein the set of slot timing values is associated with a primary cell or with a specific cell, indicated by the DCI, in which the PUCCH resource is located.

30. The base station according to claim 29, wherein, in case that the DCI includes information for indicating the specific cell associated with the PUCCH resource among the at least two serving cells, the set of slot timing values is associated with the specific cell.
